(19) United States
(12) Patent Application Publication
(10) Pub. No.: US 2004/0177021 A1
(43) Pub. Date: Sep. 9, 2004

(54) Apparatus and method for achieving enhanced returns on investments

(76) Inventors: Joseph W. Carlson, Pleasant Grove, UT (US); Timothy T. R. Vest, Orem, UT (US); Lee R. Phillips, Provo, UT (US); Clark S. Gardner, Orem, UT (US)

Correspondence Address: Wright Law Group, PLLC, ATTN: Mark F. Wright, Suite 2, 7201 West Oakland, Chandler, AZ, 85226, US

(21) Appl. No.: 10/794,442

(22) Filed: Mar. 3, 2004

Related U.S. Application Data
(60) Provisional application No. 60/452,307, filed on Mar. 5, 2003.

(51) Int. Cl. G06F 17/60

(52) U.S. Cl. 705/36

(57) ABSTRACT

The apparatus and methods of the present invention create enhanced investment returns for investors by utilizing standard insurance products and recognizing the actuarial expectation of death for lives within a pool of insured lives. In the most preferred embodiments of the present invention, a pooled investment entity, which is a tax “pass through” entity, invests in life insurance policies or otherwise secures life insurance policies placed on lives in a pool of insured lives. A projected return is calculated on an actuarial basis and actual returns are paid based on the experience of deaths in the pool of insured lives.

### CROSS REFERENCE TO RELATED APPLICATIONS

The present application claims priority under 35 U.S.C. §119(e) to U.S. Provisional Patent Application Serial No. 60/452,307, filed on Mar. 5, 2003, which is hereby incorporated by reference in its entirety.

### FIELD OF THE INVENTION

The present invention relates generally to the creation of synthetic investments and more specifically relates to the use of insurance instruments, banking principles, and tax advantaged transactions in an investment environment to increase the return on investment.

### BACKGROUND INFORMATION

Most investors are usually seeking the best possible return on their invested monies, and financial security is generally a significant issue in their selection of investment vehicles. The life insurance industry is one of the largest and most successful financial fields in the world today, providing a high level of security for investors. Accordingly, investors routinely invest in the stock and other equity instruments of the more successful life insurance companies. In the reverse, life insurance companies routinely invest in stocks, bonds and other traditional investments available to investors in the securities market. Further, individuals purchase life insurance products to provide a death benefit upon the death of the insured, and this provides an income to family members, partners, companies and others that suffer a loss upon the death of the insured. Life insurance products are also purchased by individuals as investments, because investing cash within the policies, annuities, and other insurance products often provides certain tax advantages over investments made in other vehicles, such as mutual funds, stocks, bonds, or the like.

Life insurance companies typically insure many lives in order to obtain a pool of insured lives large enough that the risks of death, from an actuarial standpoint, can be calculated with a high degree of accuracy and precision. In this fashion, an insurance company can calculate the premiums it must charge, the return on investment it must receive, and the rate of payout it will suffer upon the death of each individual insured or withdrawal of funds by the owners of the insurance products issued by the insurance company. In general, the securities market, or “public investment market,” does not view the actuarial expectation of death and payment of death benefits from life insurance companies as an investment upon which a return can be achieved.

The prevailing view of the investment community is that investment in the death benefits of life insurance policies is a losing proposition. Although the public investment market has invested in the equity instruments of the various insurance companies, the investment market has not invested directly in the insurance products, and particularly the death benefit paid upon the death of an insured. The public investment market has, however, invested in certain life insurance products where the expectation of a return on investment is derived from the cash value components of the underlying insurance policy or policies. In such a case, the investments are actually being made in the underlying investment portfolio of the life insurance policy, and the expectation of a return is being based upon the performance of the investment portfolio.

Another method of employing life insurance policies to create investment vehicles involves loans to owners of life insurance policies who are terminally ill or aged; commonly know as “viaticals.” This system provides a line of credit to those insured under an insurance policy without actually transferring ownership of the life insurance policy. The Health Insurance Portability and Accountability Act of 1996 (HIPPA) makes the proceeds of viatical settlements tax-exempt on the federal level for individuals who are terminally or chronically ill. When the insured dies, all of the proceeds of the policy's death benefit are typically not paid out because some or all of the contracted death benefit has already been consumed prior to the death of the insured.

In addition, other known investment methodologies include debt leveraged transactions using a whole or universal life insurance plan that is administered using a computer processing method to ensure lender security, accumulation of value to an employee, with reduced tax exposure. In other investment methodologies, the employer may borrow in installments to cover at least a portion of the insurance premiums on a policy owned by the employee or the company, and pays interest on the loan for the life of the plan. Other methodologies may include a situation where the employee also pays part of the premiums, and collaterally assigns the policy as security for repayment of the loan. As the insurance policy appreciates in value, premiums decrease. In this case, the employee may choose to pay down the loan and eventually eliminate premium payments, or can borrow against the policy for tax-free retirement income. Then, the excess of the death benefit over any loan principal remaining upon the death of the employee may be a tax-free payment to the employee's beneficiaries.

While these various known investment methodologies are not without merit, most existing investment methods involving insurance companies have one or more significant drawbacks, such as undesirable tax consequences or limited investment returns based on fundamental structural elements of the underlying investments. In these situations, additional opportunities for enhanced investment returns are similarly limited and lack significant investment potential. Accordingly, without developing improved methods of investing using standard life insurance products and/or without creating new investment relationships involving traditional entities in the investment markets, investment returns will continue to be sub-optimal.

### SUMMARY OF THE INVENTION

The apparatus and methods of the present invention create enhanced investment returns for investors by utilizing standard insurance products and recognizing the actuarial expectation of death for lives within a pool of insured lives. In the most preferred embodiments of the present invention, a pooled investment entity, which is a tax “pass through” entity, invests in life insurance policies or otherwise secures life insurance policies placed on lives in a pool of insured lives. A projected return is calculated on an actuarial basis and actual returns are paid based on the experience of deaths in the pool of insured lives.

### DESCRIPTION OF THE DRAWINGS

The preferred embodiments of the present invention will hereinafter be described in conjunction with the appended wherein like designations denote like elements and:

FIG. 1 is a schematic diagram of an investment relationship involving one or more investors, a pooled investment entity, an insurance company, and one or more lives within the designated pool of insured lives in accordance with a preferred embodiment of the present invention;

FIG. 2 is a schematic diagram of an investment relationship involving one or investors, a pooled investment entity, an insurance company, a qualified entity, and one or more lives of donors to the qualified entity within the designated pool of insured lives in accordance with a preferred embodiment of the present invention;

FIG. 3 is a schematic diagram of an investment relationship involving investors, a pooled investment entity, an insurance company, one or more insured lives within the pool of insured lives, and a leveraged fund source in accordance with a preferred embodiment of the present invention;

FIG. 4 is a block diagram of a computer-based system for implementing an investment method in accordance with a preferred embodiment of the present invention;

FIG. 5 is a block diagram of a computer used for implementing a computer-based method in accordance with a preferred embodiment of the present invention; and

FIG. 6 is a flow chart of an investing method in accordance with a preferred embodiment of the present invention.

### BACKGROUND ART

The present invention utilizes various concepts associated with investments, banking, insurance and the various transactions that can take place in this environment. For those individuals who are not familiar with these concepts, the explanations in the Overview section will provide the additional detail necessary to understand the present invention. Those individuals who are familiar with these concepts may proceed directly to the detailed description section below.

1. Overview

Investors

Investors make investments by using or “investing” assets to gain a profit, to increase their wealth, and/or gain a future advantage or benefit. Investors, individuals or entities, may transfer assets, i.e., invest, through pooled investment entities in order to obtain a financial return. By investing in the pooled investment entity, the investor buys an interest or share in the entire pool. For the purposes of discussion for the various preferred embodiments of the present invention, such an interest will be termed a “unit.” It is expected that the pooled investment entities will not only return the investment made or assets committed by investors, but also an increase.

Investors, individuals or entities, may or may not be willing to transfer assets to qualified entities as an expression of their desire to further the cause or causes of the qualified entities. Investors that investment in pooled investment entities desire to increase their wealth, not support the cause of a qualified entity. Investors consider any transfer of assets to a qualified entity a loss, certainly not an investment that would be expected to yield an economic return to the transferor. Investors do make loans to qualified entities, with the expectation of a return of principal and increase, or “interest” on the money loaned. Such interest is paid based upon an agreed-upon rate over a given term.

Qualified Entities

“Qualified entities” are entities that represent or promote causes that have been deemed “worthy social causes.” An entity is deemed to be a qualified entity if it is recognized by one or more United States government agencies, including the Internal Revenue Service (IRS), as an entity that is able to give a tax advantage, under the IRS Tax Code, to those persons or entities that transfer assets to benefit the qualified entity and its worthy social cause. For the purpose of discussing the various preferred embodiments of the present invention, entities that have been so recognized are termed “qualified entities.”

With the exception of a few cases, such as some charitable trusts, assets transferred from an individual or entity to a qualified entity are irrevocably placed in the control of the qualified entity and the transferor has no future contractual claim to the assets or the fruits of the assets, derived through use of the assets by the qualified entity. Although the transferor received a tax advantage for transferring the asset to the qualified entity, the transferor lost the asset. Generally, the tax advantage does not come close to restoring the value of the transferred asset to the transferor. Such tax advantaged transfers or “contributions” are certainly not considered investments. Individuals and entities regularly make transfers of assets to qualified entities in order to further the underlying social cause, not to increase the wealth of the contributing individual or entity.

Qualified entities typically recruit people and entities that will transfer assets to the cause or causes that the qualified entities represent and pursue. The expense of finding persons and entities that are willing to support a qualified entity's cause is generally a considerable expense for the qualified entity. Once recruited, the person or entity becomes essentially a valuable asset to the qualified entity, because the person or entity will likely transfer additional assets in the future to the qualified entity. The longevity and earning capacity of such persons are typically important to the qualified entity, because the longer the person lives and the greater his or her earning capacity, the better chance the qualified entity has of receiving additional transfers of assets from the person. If the person becomes unable to earn or dies, the qualified entity suffers the loss of potential future asset transfers from the person.

The qualified entity has an insurable interest in the life of each of the people that transfer assets to the qualified entity, particularly in the life of a person who has transferred an asset or assets of significant value and will likely transfer additional assets. If fact, an individual or entity that makes significant transfers to the qualified entity has a keen interest in the life of each other such transferor. Without the collective assets of the transferors, the worthy social cause, which each transferor wants to see furthered, will likely not be developed as fully and timely.

Qualified entities often approach corporate and other business entities for support of their causes. However, it would generally be considered counterintuitive to have a qualified entity approach a pooled investment entity and ask for a donation. Pooled investment entities invest money of their investors for the generation of investment income, not for the purpose of making donations to qualified entities. A donation to a qualified entity by a pooled investment entity would be considered a loss by the investors in the pooled investment entity, and investors don't like losses.

Pooled Investment Entities

There are many different types of pooled investment entities, such as unit investment trusts, real estate investment trusts, mutual funds, investment clubs, limited partnerships, and many more. The pooled investment entity simply requires a structure where two or more individuals or entities transfer assets to the pooled investment entity, i.e., invest in the pooled investment entity, with the intent of receiving their assets back and an increase or “return” from their invested assets. The transferors effectively “invest” in or through the pooled investment entity. The pooled investment entity invests the pooled assets, which it has available, in securities, real estate, or in other ways calculated to return the assets with increase to those persons or entities that invested in the pooled investment entity. The investors usually buy units in the pooled investment entities as their investment means. There are numerous advantages to investing through a pooled investment that are apparent to one trained in the art associated with such entities.

Some but not all of the pooled investment entities are “pass through” entities. A pass through entity is a separate non-taxable entity for federal income tax purposes. A pooled investment entity that is a “pass through” entity does not pay federal income tax; rather, income or loss “flows through” to the investors or “transferors,” who are taxed in their individual capacities on their distributive shares of taxable income or loss from the pooled investment entity. The income or loss of the pass through entity retains its character as it flows through to the investors. For example, an investment by the pooled investment entities in tax-free bonds would yield an investment return to the investors in the pass through entity that would be tax free to the investors upon its receipt. If the pass through entity were to sell assets, upon which it was entitled to claim capital gains treatment, that capital gain aspect would pass through to the individual investors, and they would claim a capital gain for their distributive share of the gain on their individual income tax returns. Even though all of the tax consequences of actions taken by the pass through entity flow through to the individual investors, it should be noted that the pass through pooled investment entity is a tax-reporting entity that must file annual state and federal tax returns.

A traditional pooled investment entity, where investors are pooling their assets as a true investment venture, such as a unit investment trust, is usually funded through sales of large numbers of interests, i.e., units, in the entity. There are often thousands of investors. In the present invention an entity with a large number of investors is envisioned. The number of investors in the pooled investment entity is not a limiting factor in the current invention. However, many pass through entities (i.e., sub chapter S corporations) are limited in the number of investors and the type of investors that can participate in the entity. Such limited pass through entities may place limitations on the invention, because of the large amount of money that has to be raised in order to secure the desired number of life insurance products.

Pooled investment entities commonly “commit” or “transfer” their assets to investments in “traditional investments,” such as the stock market, bond market, real estate market or some other area of traditional investing where an economic risk is acceptable. In the present invention, such traditional investments are contemplated, and other novel ways of committing assets of the pooled investment entity are created.

The pooled investment entity used in the current invention can commit its assets in many ways. By way of non-limiting examples, the assets may be committed directly, such as making the purchase of stocks, bonds, or other investment vehicles. The assets could be committed through the purchase of life insurance products. The assets may also be committed by using them as security in order to secure financing, such as borrowed funds, i.e., “leveraged funds,” which can then be used to purchase or otherwise secure the life insurance products or other assets in which the pooled investment entity invests. In such a case, the pooled investment entity would effectively be “financing” the assets used as investments. The pooled investment entity would not be considered to be making a loan to a provider of the investment asset, such as a life insurance policy, or any other party in the transaction. Using the assets as security may require them to be placed in a position where they are used as collateral. The assets could be committed in other ways, for example through assignment, in order to act as security and secure the financing, i.e., borrowed funds or leveraged funds. However it is accomplished, the current invention requires a commitment of assets held by a pooled investment entity used, directly or indirectly through any means, to ultimately “secure,” “purchase,” or otherwise place the life insurance products in force.

The pooled investment entity's asset(s) could be transferred through one of more other persons or entities before they are indirectly used to secure the assets which makeup the investments of the pooled investment entity, including life insurance products. In the present invention, all that is necessary is a commitment of pooled investment entity assets and the eventual purchase of life insurance products on a life in a pool of insured lives, which purchase would not have been made without the pooled investment entity's assets being committed in some sense of the word “committed.” To make an investment in life insurance products is also counter intuitive to the normal investment practices of pooled investment entities.

There are many reasons why this invention presents a novel combination of pooled investment entities, life insurance products, and qualified entities. The “transfer” or “commitment” by a pooled investment entity of any of its capital, i.e., assets, to a qualified entity is an action not presently contemplated by a pooled investment entity. To make such a transfer, and irrevocable commitment of the asset to the qualified entity, is counter intuitive to traditional investment theories.

Likewise, a pooled investment entity's use or “commitment” of its capital, i.e., assets, to purchase life insurance on lives is an action not presently contemplated by pooled investment entities as an investment strategy. Pooled investment entities do not generally purchase life insurance policies for a number of reasons. Some of the reasons include the pooled investment entity' innate ability to make its own investments in large blocks. The pooled investment entity normally has a huge investment pool and can obtain the best investment advantage available in the market.

A pooled investment entity may invest in a life insurance company, but it would not invest through a life insurance company, because it can get the same returns in the market as the life insurance company can. It should be noted that a purchase of a life insurance product is basically an investment through a life insurance company. Life insurance products have historically been considered poor investments. Any investment made though a life insurance company by the pooled investment entity would simply reduce the return to investors of the pooled investment entity, because the life insurance company would take a profit off of the investment before recognizing any return due to the pooled investment entity.

Additionally, any investment in life insurance policies by the pooled investment entity would be counterintuitive, because the cost of insurance (i.e., the cost of providing the death benefit) removes a significant value from the investment.

There is a return based upon the cost of insurance when the insured dies. The “return,” in the form of a death benefit from an insurance product, will be recognized at a time uncertain. The pooled investment entity has no control over the time of death of an insured. In the case of each individual insured, the return of the cost of insurance may or may not produce a positive return depending upon how high the cost of insurance premium is to start with and how high it goes, which is dependant upon how long the insured lives. Pooled investment entities invest in vehicles that yield a time specific return or at least vehicles where the time of the return can be controlled by the pooled investment entity. It is counter intuitive to invest in a vehicle where the timing of the possible return is uncertain and uncontrolled as would be the receipt of the death benefit upon the death of the insured.

Upon the death of an insured, a death benefit is paid and a return is received. However, if the insured individual or individuals live until full life expectancy or beyond, the insurance company has taken the premium money paid and made a profit on it. If such an insured were a large sophisticated investor, they would be further ahead financially to have taken their premium dollars over the years and invested them directly for themselves. Thus, there is generally a cost of insurance that is lost by the premium payor to the insurance company, and if the pooled investment entity is assumed to be able to invest its pool of assets in the same manner as the insurance company, it would typically not invest through the insurance company and lose the cost of insurance and the “profit” retained by the insurance company on the monies typically taken in by the insurance company. In general, a pooled investment entity would be better off making its own investments than it would be paying the insurance company to make investments for them.

Also, pooled investment entities do not purchase life insurance, because they have not assembled the “lives” to insure. It may be argued that the pooled investment entities have an insurable interest in their investors, but it would be counterintuitive to use the investor's own money and purchase a life insurance policy on the life of the investor. If the investor wanted to purchase life insurance on himself, it would be much more economical to purchase it directly rather than impose a pooled investment entity in the middle of the transaction. In general, people are not willing to let other people insure their lives and receive nothing in return.

Life Insurance Companies and Products

Life insurance companies can be organized as corporations, trusts, limited liability companies or any other form of business entity. Life insurance companies or “carriers” insure the lives of individuals and provide products (life insurance policies), which provide payments or “death benefits” at the death of an insured individual. A beneficiary is a person or entity that receives all or a part of a payment from a life insurance company as a result of having an interest in an insurance product.

Life insurance companies provide many types of products. For purposes of the present invention, life insurance products (insurance products) shall include, but not be limited to, any traditional life insurance products known to those skilled in the art that pay a death benefit. Life insurance products shall also include any similar or related life insurance products later developed and suitable for the purposes described herein. Insurance products shall also specifically include, by way of illustration and not limitation, annuities, whether or not they provide a death benefit, any product with an actuarial aspect, or any other investment vehicle offered by an insurance company.

Any person or entity (i.e., banks, credit unions, fraternal organizations, etc.) acting to fill the functions normally performed by an insurance company whether or not such person or entity is called an “insurance company,” shall be considered an “insurance company” for purposes of discussing the various preferred embodiments of the present invention. Life insurance products may be identified by terms such as “permanent,” “universal,” “fixed,” “guaranteed,” “whole life,” “term,” “indexed,” “variable,” or any one of many other insurance terms. Similarly, life insurance products encompassed within this definition include, but are not limited to, single premium products and multiple premium products. Further, life insurance products used in conjunction with the various preferred embodiments of the present invention may also provide benefits in addition to or in lieu of the standard death benefit.

Ideally, an insurance company takes in sufficient money, in the form of premiums, and makes sufficient returns, through investing that money, so that they have more money at an insured's death than they need to pay out upon such death. In order to be sure that an insurance company is able to meet their obligation to pay periodic payments, if required, and to pay out death benefits, an insurance company will insure many people. Most life insurance products have an actuarial basis. The insurance company insures a “pool of insured lives,” i.e., many insured lives. A “pool of insured lives” is simply a group of two or more lives where each life is covered by a life insurance product. Most commonly the life insurance product will have a death benefit component, i.e., a life will be insured against the risk of death or some other event (injury, etc.).

Given a pool of insured lives, with a sufficient number of lives, the life insurance company can then actuarially predict the rate the company will have to pay money out in the form of death benefits. The rate of payout is based upon the statistical expectation or “actuarial expectation” of death within the pool of insured lives. If the pool of insured lives is large enough, the insurance company can predict with statistical (actuarial) accuracy what premium funds they have to collect, the length of time they will have the funds to invest, and the rate those funds have to be invested at in order for the insurance company to make a profit over and above its claims and costs of doing business.

At the time of each death within the pool of insured lives, the insurance company is obligated to make a death benefit payment. Essentially, the insurance company loses money each time one of its insureds dies. The insurance company makes all of its actuarial studies in order to predict the length of life for each life in the pool of insured lives, and thus, the length of time the insurance company will have the insured's premium dollars to invest. The insurance company's ability to invest the premium dollars, obtained from the insured, ends at the time they have to make the death benefit payment.

In the event that the actuarial calculations are not correct, the insurance company will lose profit and may become insolvent. The actuarial calculations themselves may be in error, too small of a pool of insured lives may have been used in the calculations, or an unexpected large number of individuals (lives) within the pool may die, and the insurance company will lose financially. In order to hedge against such losses, insurance companies often “reinsure” their risks by having other insurance companies share some of the risk of loss from deaths within the insuring or “servicing” life insurance company's pool of insured lives. Thus, the pool of insured lives of the insuring company is greatly expanded by making it essentially a subset of the pool of insured lives held by two or more insurance companies collectively. Each reinsurer purchases a part of the premium stream, with the expectation that it can invest the premium assets it receives and obtain a profit.

By reinsuring and effectively creating a bigger pool of insured lives, an insurance company is able to reduce its risk, because the bigger the pool of insured lives, the more accurate any actuarial calculations will be. With accurate actuarial predictions of the length the lives within the pool of insured lives, the insurance company will know more exactly how long it will be able to invest the premium dollars it receives from each insured.

Not all lives are insurable. In exchange for a “premium” or premium payments, a life insurance company may issue a life insurance policy on the life of an individual that meets certain health, age, and other standards. Once the policy is issued on the life of an individual, the individual is considered to be an “insured.” Standard United States insurance companies, which are admitted to do business in one or more states, will only issue a policy to an owner that has an insurable interest in the life to be insured. The owner or other persons or entities, or a combination of them, may be named by the owner as beneficiary of the death benefit to be paid by the insurance company on the policy at the death of the insured. Multiple beneficiaries can be named to receive portions of the death benefit in a single life insurance policy. A person or entity named as a beneficiary to a life insurance policy does not need to have an interest in the insured, which rises to the level of an “insurable interest” that would permit the beneficiary to have the policy issued to them as the owner.

“Foreign” insurance companies, i.e., those not registered in any state or “admitted” to do business through agents in the United States, have different standards related to the insurance underwriting required in order to issue an insurance policy. Such foreign insurance companies often treat the issue of “insurable interest” differently. It should be noted that such foreign insurance companies could insure the life of a United States resident, without being “admitted” as a carrier by the various state and federal regulatory agencies that control the insurance industry in the United States and various states. In fact, such foreign carriers often act as “reinsures” of life insurance policies issued by United States admitted insurance companies. It is certainly possible to insure the life of a person who is not a United States citizen or resident and name a United States citizen or resident, either a person or an entity, as the beneficiary of all or a portion of the death benefit or other rights in the insurance policy.

Payment of the death benefit has various estate tax (death tax, inheritance tax, disposition tax, or deemed disposition tax imposed by a local, state or national government) and income tax effects on those receiving the payment. Such effects are well documented in the local, state or national tax codes, such as the IRS Tax Code. They are also documented by regulations, related court cases, and other rulings that carry the weight of law. Generally, life insurance proceeds (death benefits) are not considered income to the beneficiaries who receive such death benefits from policies. Such proceeds are broadly considered a replacement of a loss of the physical life, earning potential, and other benefits associated with the life of the insured offered the owner and or the beneficiaries of the policy.

Banking Industry

The banking or finance industry receives a return on its assets in large part by lending its assets and receiving an interest on the loaned assets. One source of borrowers is those individuals that need to purchase large life insurance policies, i.e., policies that pay a substantial death benefit. Wealthy individuals often want large life insurance policies, but the after tax costs, gift tax considerations of funding the policies outside of their estate, the drain on capital, and other problems make the purchase of large life insurance policies problematic, if not impossible, for many who need such policies. Borrowing funds to pay the premiums, and possibly even the interest on the actual amounts loaned, solves cash flow and tax problems encountered by purchasers of large insurance policies. If the contracts are arranged such that the insurance death benefit pays all or a portion of the loaned amounts back to the lender, the lender has the opportunity to loan large amounts of money in a fairly secure environment.

In order to secure its position, the lender requires assets to be placed under its management or to be encumbered by a collateralization agreement or third-party assignment. Lending arrangements that require the placement of assets under management are not as desirable as those that simply require the collateralization of assets. The assets may be provided by the borrower or may come from any other source of assets acceptable to the lender.

It would be possible to use the assets of a pooled investment entity as the collateral necessary to induce the lender to loan premium funds and even accrue interest, in order to permit the purchase of life insurance on the life of an individual. However, it would be counter intuitive to encumber the assets of a pooled investment entity. Investors transfer assets to a pooled investment entity with the intent that the pooled investment entity will invest the assets, not use them for collateral. Historically, large pooled investment entities have not been known to pledge their assets as collateral, especially as collateral on a life insurance policy.

When funds are borrowed to pay premiums and/or the interest that is required on the premium amounts borrowed, the collateralization used, or assets of the borrower are “leveraged.” The insurance purchased using such borrowed funds is often referred to a “premium financed insurance” or “leveraged life insurance.”

When a pooled investment entity uses its assets to secure or “collateralize” borrowed funds, i.e. “leveraged funds,” the lender is truly making a loan, complete with an interest calculated thereon. The leveraged funds may be used to pay the premiums on life insurance products. Although, the pooled investment entity may be the owner and/or beneficiary of all or a part of the insurance products obtained using the borrowed funds, it is likely that the lender will be named as primary beneficiary of the insurance policies. But the pooled investment entity will receive a portion of the death benefit, either directly from the insurance company or indirectly. When a pooled investment entity uses its assets to secure funds that are then used to purchase a life insurance product rather than directly purchasing a policy using its assets, the pooled investment entity may or may not be making a loan in any respect.

Limited Partnerships

A number of structures, similar to pooled investment entities, exist and may be used to achieve tax-advantaged estate planning results. The most popular of these structures is known as the family limited partnership. Although money given to a family limited partnership can be “pooled,” the purpose of such partnerships is typically estate planning, not the generation of enhanced investment returns for the contributors. In fact, these entities are used to “shift income” away from the contributors (those committing assets to the limited partnership) to others within the limited partnership structure. A family limited partnership is often used to purchase and hold one or more life insurance policies, because if the partnerships are structured properly, the life insurance death benefits will be paid outside of the insured's estate. One or more policies may be held in such an entity, but the purpose of the entity is certainly not to return an investment to the contributors. Note that those individuals or entities transferring assets to the family limited partnership do not normally do so to invest; they are contributing specific assets to the family limited partnership so as to divest themselves of the assets they contribute.

It is possible to have a limited partnership where individuals and or entities invest as limited or general partners. Such entities are basically pooled investment entities. The number of partners is usually relatively limited and they are usually structured to accomplish a specific project, such as a real estate development. They are not presently structured to invest in life insurance products covering lives within a pool of insured lives in order to obtain a return on investments made.

Venture Capital Trust

Yet another investment structure known to those skilled in the art is the venture capital trust (VCT). In the case of a VCT the British government has created a trust with a unique tax advantage to encourage the creation of seed venture capital that can be used to stimulate startup companies in the United Kingdom (UK). The VCT actually removes permanent capital from capital markets using special purpose tax policy.

A VCT is an example of a pooled investment entity, which is a pass-through entity that achieves a unique ability to return tax-advantaged investments to its investors. A venture capital trust (VCT) is a publicly traded unit investment trust entity that invests in shares or debentures of other corporations in the UK. The Inland Revenue of the United Kingdom allows income tax relief to encourage qualified types of UK-based investment activity through government tax policy. To qualify as a UK VCT, the trust cannot invest in any specified list of business classifications. As such, investors in VCTs purchase investment trust units in pools of equities in high-risk companies where their VCT shares are marketable over a counter in an exchange.

Purchasing a VCT unit generates an immediate tax relief specified by a maximum percentage rate by UK tax code subject to a stated limit per tax year. To keep this relief, there is a specified VCT holding period. Any dividends on these shares will be free of taxation. The VCT will not itself pay tax on any capital gains it makes purely passing through the same benefit to the unit investor. Furthermore, the investor will not pay tax on any capital gain on disposal of their VCT unit shares provided that the limit per year tax threshold is not exceeded. In addition, enhanced investment performance is achieved through VCTs by providing deferral of capital gains tax (CGT). If an investor in the UK has any capital gain, the CGT may be postponed by purchasing VCT units within a certain period. This period begins twelve months before the date of the gain and ends twelve months after it. This deferral is subject to the limit per year tax exclusion, but if the two-year reinvestment period straddles three tax years (as normally it will) it is possible to defer tax on a capital gain of up to three times the limit. But this allowance is simply a deferral. The capital gain is the amount of the gain at the time that it is reinvested into the new VCT units. When the investor eventually disposes of said unit shares, the proportional gain disposed of is no longer deferred and becomes chargeable to that tax year.

Investors in the UK need not always subscribe to new shares. Investors may purchase used VCT unit shares and receive tax-free dividends and eventual tax-free capital gains provided that the yearly tax limit is observed. The prices of nearly all VCTs in the UK are quoted on exchanges. Investor's purchasing second-hand VCT shares receive neither the immediate tax deduction nor the deferral of capital gains on other assets allowed by Inland Revenue. Because newly issued VCT unit shares carry the more valuable tax relief, they carry a premium over the second-hand VCT unit shares also quoted in the market by purchase. The VCT makes its investment in equity ownership of high-risk companies. It teaches the use of pooled investment entity assets to make standard equity investments. In this case the risk is so great that the government will give the investors tax advantages in order to induce them into making the investments. Although it is a publicly traded pass through pooled investment entity, it sheds no light on the current invention.

2. Detailed Description

apparatus and methods of the present invention create enhanced investment returns for investors in pooled investment entities by utilizing standard insurance products and recognizing the tax aspects of such products and the actuarial expectation of death for lives within a pool of insured lives. In the most preferred embodiments of the present invention, a pooled investment entity, which is a tax “pass through” entity, invests, based on actuarial expectations, in life insurance policies or otherwise secures life insurance policies placed on lives in a pool of insured lives with actual investment returns being paid on the experience of death with the pool of insured lives.

In one of the simplest expressions of the present invention, one or more investors place or “transfer” assets into a pooled investment entity. The pooled investment entity then secures life insurance policies, or causes such life insurance policies to be secured, on the lives of donors to a specific qualified entity or other individuals that the pooled investment entity selects. Finally, the pooled investment entity pays a return to the pooled investment entity based on the actual experience of deaths in the insured pool.

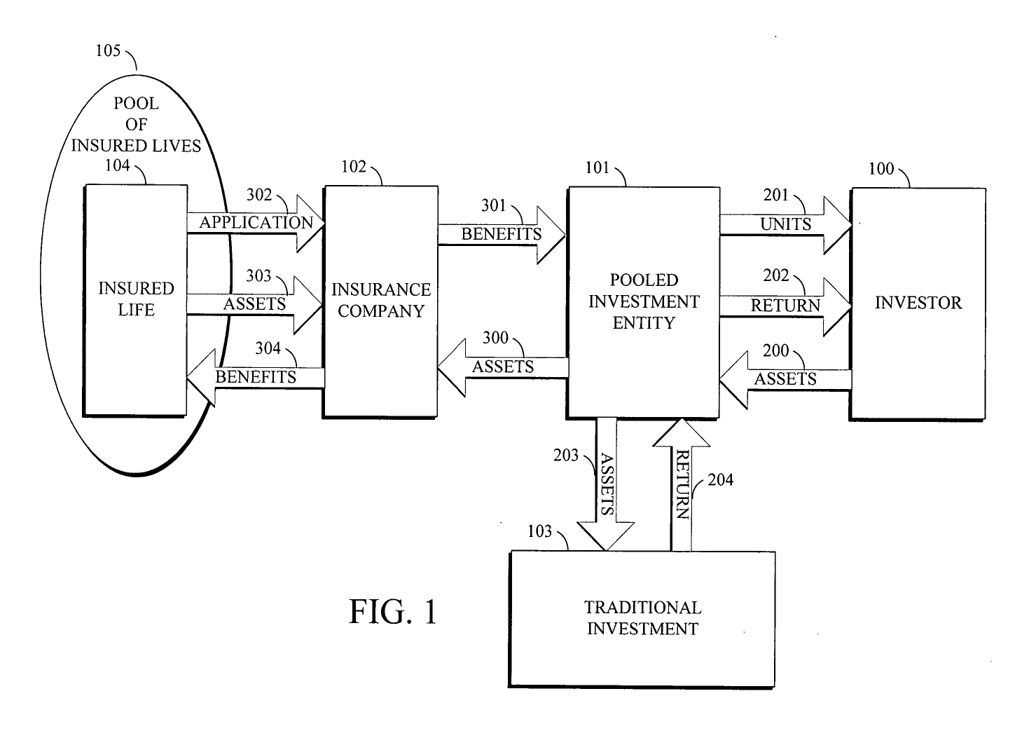

Referring now to FIG. 1, a schematic diagram of an investment relationship using a pass-through entity in accordance with a preferred embodiment of the present invention is depicted. As shown in FIG. 1, an investor 100 transfers assets 200 (invests) into a pooled investment entity 101. For purposes of this embodiment of the present invention, pooled investment entity 101 is a pass-through entity, such as a unit investment trust, partnership, limited partnership, limited liability company, etc. Pooled investment entity 101 is structured such that ownership interests or units 201 in its investment pool (assets) can be purchased as investments by investor 100. Invested assets 200 are received by pooled investment entity 101 in exchange for units 201, under the terms and conditions as set forth in the mutual bylaws and/or trust agreements adopted by pooled investment entity 101. Pooled investment entity 101 pools the invested assets 200 and then invests the pool of assets in a way calculated to provide a return 202 to investor 100, which returns the invested assets 200 plus an increase. If the investment is properly understood, return 202 should be a positive return, rather than a loss.

Pooled investment entity 101 uses invested assets 200 it pools from each individual investor 100 and invests some or none of the pooled assets 203 in one or more traditional investments 103 of its choice. The traditional investments could be municipal tax-free bonds, real estate, stocks, or any other type of investment calculated to yield a positive return 204. Such traditional investments are routinely made by pooled investment entities.

In the various preferred embodiments of the present invention, pooled investment entity 101 takes all or a part of its pooled assets and commits such assets 300 to the purchase or “securing” of life insurance products from an insurance company 102. The insurance products supplied by insurance company 102 insure one or more insured lives 104 within the pool of insured lives 105. In order to insure each such life, each individual being insured must fill out the required insurance application 302 and supply it to insurance company 102. Following evaluation, insurance company 102 will decide whether or not it will issue an insurance product, such as a standard life insurance policy. With the necessary assets 300 committed from pooled investment entity 101 combined with assets 303, if any, and with the necessary approvals, policies are issued and insurance company 102 insures one or more insurable lives 104. It is possible that an insured life 104 may transfer assets 303 to pay for a portion of the purchase price required in order to secure an insurance product from insurance company 102 upon his or her life.

Any insurance product issued will most likely be owned by pooled investment entity 101, but it could be owned by insured life 104 or any other person or entity. The insurance products supplied by insurance company 102 will pay a benefit 301 to pooled investment entity 101 at some point in the future. Insurance company 102 may or may not also pay a benefit 304 to insured life 104 or to the beneficiary named by the insured. The event triggering such payment of benefits 301 and/or benefit 304 could be any definable event, but it will most often be the death of insured life 104.

Upon receipt of a benefit 301 payment, pooled investment entity 101 will take all, a portion, or none of the benefit and pass through such portion of the benefit as return 202. Benefits 301 will be retained or distributed to investor 100 based upon the agreed division of such benefits. The amount and timing of return 202 are dependent upon the actual experience, i.e., the timing of the death of individual insured lives 104 within pool of insured lives 105. Benefit 304, if any, is not based upon the actuarial expectation of the death of individual insured lives 104 within the pool of insured lives 105. It is simply based upon the death of insured life 104 to which the benefit is attached. A benefit 304 distribution is made only upon the occurrence of the triggering event associated with a single insured life 104 to which the benefit is attached.

Should pooled investment entity 101 obtain a return 204 from traditional investment 103, it will also take all, a portion, or none of return 204 and pass through such portion of such return as return 202. Return 204 will be retained or distributed to investor 100 based upon the agreed division of such returns. At the end of a previously established term, payment of returns 202 will end in accordance with the agreement between pooled investment entity 101 and investor 100.

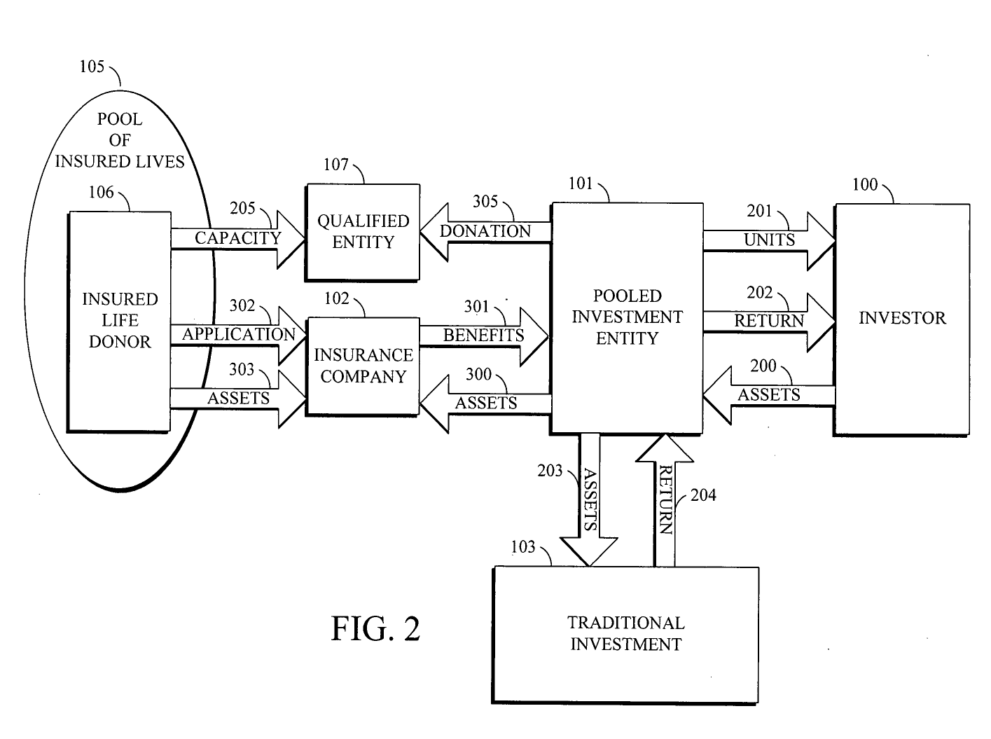

Referring now to FIG. 2, a schematic diagram of an investment relationship for raising funds for a qualified entity in accordance with a preferred embodiment of the present invention is depicted. As shown in FIG. 2, an investor 100 transfers invested assets 200 (invests) into a pooled investment entity 101. For purposes of this embodiment of the present invention, the pooled investment entity 101 is a pass-through entity, such as a unit investment trust, partnership, limited partnership, limited liability company, etc. The pooled investment entity 101 is structured such that ownership interests or units 201 in its investment pool (assets) can be purchased as investments by an investor 100. Invested assets 200 are received by the pooled investment entity 101 in exchange for units 201, under the terms and conditions as set forth in the mutual bylaws and/or trust agreements adopted by the pooled investment entity 101. Pooled investment entity 101 pools invested assets 200 and then invests the pool of assets in a way calculated to provide a return 202 to investor 100, which returns invested assets 200 plus an increase. If the investment is properly understood, return 202 should be a positive return, rather than a loss.

Pooled investment entity 101 uses invested assets 200 it pools from each individual investor 100 and invests some or none of pooled assets 203 in one or more traditional investments 103 of its choice. The traditional investments could be municipal tax-free bonds, real estate, stocks, or any other type of investment calculated to yield a positive return 204. Such traditional investments are routinely made by various pooled investment entities.

In the current invention, pooled investment entity 101 takes all or a part of its pooled assets and commits assets 300 to the purchase or “securing” of life insurance products from insurance company 102. The insurance products supplied by the insurance company 102 insure one or more insured life donors 106 within the pool of insured lives 105. In order to insure each such life, each individual being insured must fill out the required insurance application 302 and supply it to the insurance company 102. Following evaluation, the insurance company 102 will decide whether or not it will issue an insurance product, such as a standard life insurance policy. With the necessary assets 300 committed from pooled investment entity 101 combined with assets 303, if any, and with the necessary approvals, policies are issued and insurance company 102 insures one or more insured life donors 106. It is possible that an insured life donor 106 may transfer assets 303 in order to pay a portion of the purchase price required in order to secure an insurance product from insurance company 102.

This preferred embodiment of the present invention includes a means of raising funds for a qualified entity 107. Qualified entity 107 recruits donors and the donors become all or a part of multiple insured life donors 106 within the pool of insured lives 105. More than one qualified entity could participate in supplying donors to act as insured life donors 106. Pool of insured lives 105 could contain lives other than insured life donor(s) 106. When the donor allows insurance to be issued from insurance company 102, the insured life donor 106 is actually donating a portion of his or her insurable capacity 205 to the qualified entity 107. At a future time the pooled investment entity 101 may make a donation 305 to the qualified entity 107, and the qualified entity will be enriched thereby. Any donation 305 made by the pooled investment entity 101 is made as a donation from the pooled investment entity and is independent of the actuarial expectation of death within pool of lives 105 or any return 202 paid to investor 100.

Any insurance product issued may be owned by pooled investment entity 101. The insurance products supplied by insurance company 102 will pay a benefit 301 to pooled investment entity 101 at some point in the future. The event triggering such payment of a benefit 301 could be any definable event, but will most often be the death of insured life donor 106.

Upon receipt of a benefit 301 payment, pooled investment entity 101 will take all, a portion, or none of the benefit and pass through such portion of the benefit as return 202. Benefit 301 will be retained or distributed to investor 100 based upon the agreed division of such benefits. The amount and timing of return 202 will be dependent upon the actual experience of the death of each of individual insured life donors 106 within the pool of insured lives 105.

Should pooled investment entity 10 obtain a return 204 from traditional investment 103, it will also take all, a portion, or none of return 204 and pass through such portion of such return as return 202. Return 204 will be retained or distributed to investor 100 based upon the agreed division of such returns. In exchange for total payment of returns 202, pooled investment entity 101 will at some point require return of unit 201 that had previously been transferred to investor 100.

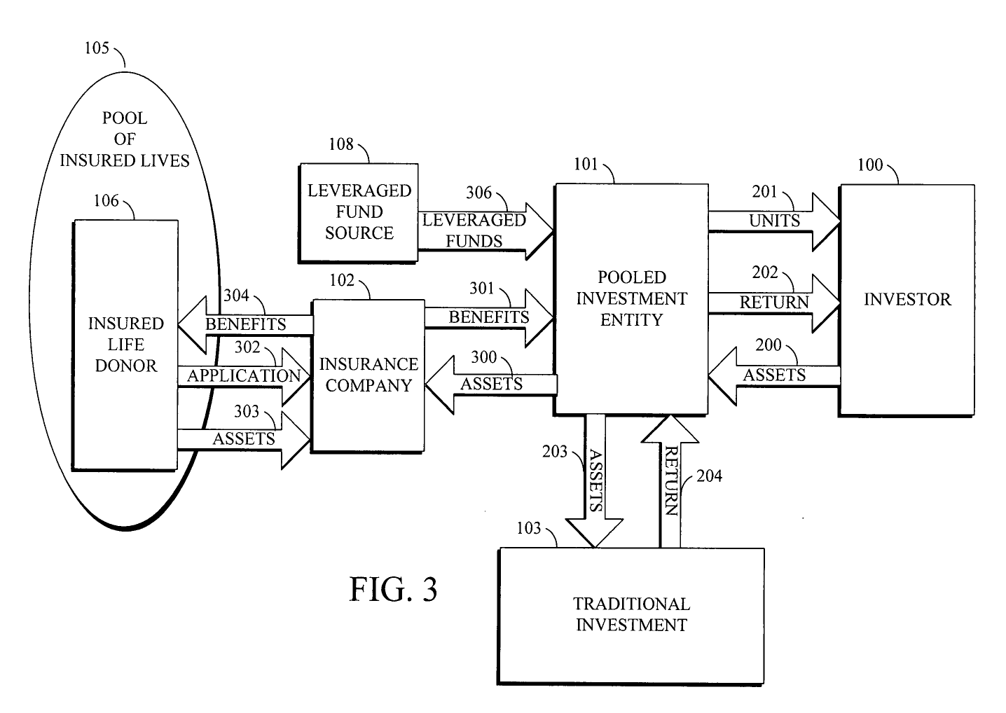

Referring now to FIG. 3, a schematic representation of an investment relationship in accordance with a preferred embodiment of the present invention depicts a method where the assets of pooled investment entity 101 are used to secure leveraged funds 306 from a financial institution or leveraged fund source 108. As shown in FIG. 3, an investor 100 transfers assets 200 (invests) into a pooled investment entity 101. For purposes of this preferred embodiment of the present invention, pooled investment entity 101 is a pass-through entity, such as a unit investment trust, partnership, limited partnership, limited liability company, etc. Pooled investment entity 101 is structured such that ownership interests or units 201 in its investment pool (assets) can be purchased as investments by investor 100. Invested assets 200 are received by pooled investment entity 101 in exchange for units 201, under the terms and conditions as set forth in the mutual bylaws and/or trust agreements adopted by pooled investment entity 101. Pooled investment entity 101 pools invested assets 200 and then invests the pool of assets in a way calculated to provide a return 202 to the investor 100, which returns the invested assets 200 plus an increase. If the investment is properly understood, the return 202 should be a positive return, rather than a loss.

Pooled investment entity 101 uses invested assets 200 it pools from each individual investor 100 and invests some or none of pooled assets 203 in one or more traditional investments 103 of its choice. The traditional investments could be municipal tax-free bonds, real estate, stocks, or any other suitable type of investment calculated to yield a positive return 204. Such traditional investments are routinely made by pooled investment entities.

In the preferred embodiment of the present invention shown in FIG. 3, pooled investment entity 101 uses its assets in order to secure leveraged funds 306 from a leveraged fund source 108. Any assets, which pooled investment entity 101 has control over, could be used to secure leveraged funds 306. The assets could include, but are not limited to, all assets retained within the pooled investment entity 101, the assets invested in traditional investments 103, and assets held within insurance products issued by insurance company 102. The pooled investment entity 101 could obtain a bank letter of credit to secure the leveraged funds 306. The leveraged funds 306 can be secured by numerous means.

As shown in FIG. 3, leveraged funds 306 are shown being transferred to pooled investment entity 101. All or part of leveraged funds 306 could be transferred directly to insurance company 102 in order to secure insurance products on insurable lives 106 within the pool of insured lives 105. All or a portion of the leveraged funds 306 could be transferred directly to one or more individuals who are acting as an insured life 106. The leveraged funds 306 could be transferred to any intermediary, but ultimately all or part of the funds will directly or indirectly be used to purchase insurance products from insurance company 102 on lives within the pool of insured lives 10. Pooled investment entity 101 may have a direct or indirect benefit interest in one or more of such insurance products.

In the preferred embodiment of the current invention shown in FIG. 3, the pooled investment entity 101 could combine its assets with leveraged funds from the leveraged fund source 108 in order to purchase or “secure” life insurance products from insurance company 102. The insurance products supplied by the insurance company 102 insure one or more insured life 106 within the pool of insured lives 105. In order to insure each such life, each individual being insured must fill out the required insurance application 302 and supply it to the insurance company 102. It is possible that an insured life 106 may transfer assets 303 to pay for all or a portion of the purchase price required in order to secure an insurance product from the insurance company 102 upon his or her life. Following evaluation, the insurance company 102 will decide whether or not it will issue an insurance product, such as a standard life insurance policy. With the necessary assets 300 committed from the pooled investment entity 101 combined with the assets 303, if any, and with leveraged funds 306, once the necessary approvals are made by the insurance company 102, policies are issued and the insurance company 102 insures one or more insured lives 106.

Any insurance product issued will most likely be owned by the pooled investment entity 101, but it could be owned by the insured life 106 or any other person or entity. It may be owned by the leveraged fund source 108. Such insurance product may be assigned or pledged to the leveraged fund source 108. The insurance products supplied by the insurance company 102 will pay a benefit 301 to the pooled investment entity 101 at some point in the future. Insurance company 102 may or may not also pay a benefit 304 to the insured life 106 or to the beneficiary named by the insured. The event triggering such payment of a benefit 301 and/or benefit 304 could be any definable event, but it will most often be the death of the insured life 106. Rather than paying all or any benefits 301 and/or benefit 304, the insurance company 102 may pay all or a portion of the benefits directly to the leveraged fund source 108.

Upon receipt of a benefit payment 301, pooled investment entity 101 will take all, a portion, or none of the benefit and pass through such portion of the benefit as return 202. All or a part of benefits 301 will be retained by pooled investment entity 101 for use by the entity, transferred to leveraged fund source 108, or distributed to investor 100 based upon the agreed division of such benefits. The amount and timing of return 202 are dependent upon the actual experience of the death of individual insured lives 106 within the pool of insured lives 105. The benefit 304, if any, is not based upon the actuarial expectation of the death of individual insured lives 106 within the pool of insured lives 105. It is simply based upon the death of the insured life 106 to which the benefit is attached. A distribution of benefit 304 is made only upon the occurrence of the triggering event associated with the single insured life 106 to which the benefit is attached. If pooled investment entity 101 were to pay a benefit to the insured life 106, in lieu of or in addition to benefit 304, such benefit would be paid upon the triggering event and be independent of the actuarial expectation of death of individual insured lives 106 within the pool of insured lives 105.

Should pooled investment entity 101 obtain a return 204 from traditional investment 103, it will also take all, a portion, or none of return 204 and pass through such portion of such return as return 202. Return 204 will be retained or distributed to investor 100 based upon the agreed division of such returns. At the end of a previously established term, payment of returns 202 will end in accordance with the agreement between pooled investment entity 101 and investor 100.

Return of leveraged funds 306 to leveraged fund source 108 plus interest thereon can be made by diverting insurance benefits, paid on the insurance products that insurance company 102 issued upon lives for which leveraged funds were used to secure the said insurance products. All insurance benefits could be paid as benefits 301 to pooled investment entity 101, and pooled investment entity 101 could make such a return plus interest to leveraged fund source 108. Insurance products could be put in place by insurance company 102 that would provide benefits specifically to make the return of leveraged funds 306 to leveraged fund source 108 and also provide benefits 301 and/or benefits 304, if such benefits are paid at all.

Those skilled in the art will recognize that the preferred embodiments of the present invention described above in FIGS. 1-3 are well suited for many adaptations and numerous variations. For example, benefit 304 in FIG. 1 and FIG. 3 could be paid as part of benefit 301 and pooled investment entity 101 could route part of the benefit payment to the insured life 106. A benefit similar to benefit 304 could be provided in FIG. 2. It should be noted that the three embodiments described in conjunction with FIGS. 1-3 may also be combined in various ways to accomplish the purposes of the present invention. For example, the assets of qualified entity 107 depicted in FIG. 2 could be used to secure leveraged funds 306 obtained from leveraged fund source 108 in FIG. 3. The various elements disclosed in conjunction with the preferred embodiments of the present invention can be linked in numerous ways, all of which are within the bounds of the current invention and claims made herein.

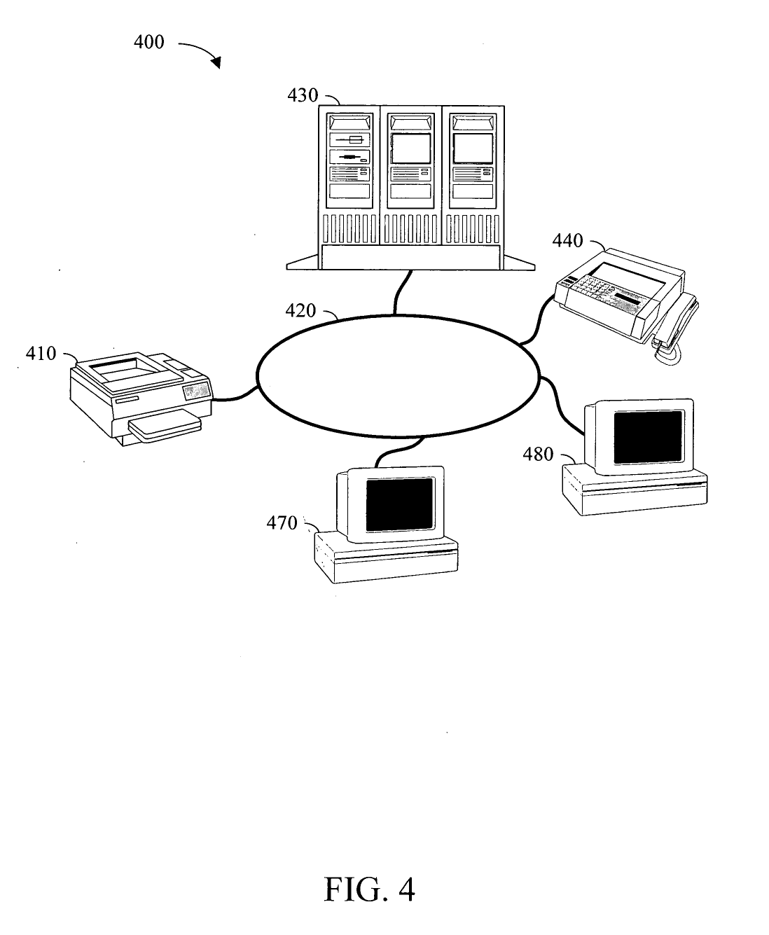

Referring now to FIG. 4, a computer-based investment profile system 400 for implementing investment methods in accordance with a preferred embodiment of the present invention includes: a data server 430; an information requesting computer system 470; and an information providing computer system 480, all connected or coupled via a network 420. Additionally, an optional printer 410 and an optional fax machine 440 are shown. Taken together, investment profile system 400 provides a way for investors, brokers, qualified entities, insurance product providers, dealers, and the like to more efficiently and effectively create, investigate, package and provide various types of investment opportunities as described herein in conjunction with the preferred embodiments of the present invention.

Data server 430 represents a relatively powerful computer system that is made available to information requesting computer system 470 and information providing computer system 480 via network 420. Various hardware components (not shown this FIG.) such as external monitors, keyboards, mice, tablets, hard disk drives, recordable CD-ROM/DVD drives, jukeboxes, fax servers, magnetic tapes, and other devices known to those skilled in the art may be used in conjunction with data server 430. Data server 430 may also provide various software components (not shown this FIG.) such as database servers, web servers, firewalls, security software, and the like. The use of these various hardware and software components is well known to those skilled in the art. Given the relative advances in the state-of-the-art computer systems available today, it is anticipated that functions of data server 430 may be provided by many standard, readily available data servers. Depending on the desired size and relative power required for data server 430, storage area network technology may also be deployed in certain preferred embodiments of the present invention.

Information requesting computer system 470 may be any type of computer system known to those skilled in the art that is capable of being configured for use with investment profile system 400 as described herein. This includes laptop computers, desktop computers, tablet computers, pen-based computers and the like. Additionally, handheld and palmtop devices are also specifically included within the description of devices that may be deployed as an information requesting computer system 470. It should be noted that no specific operating system or hardware platform is excluded and it is anticipated that many different hardware and software platforms may be configured to create information requesting computer system 470. As previously explained in conjunction with data server 430, various hardware components and software components (not shown this FIG.) known to those skilled in the art may be used in conjunction with information requesting computer system 470.

Similarly, information providing computer system 480 may be any type of computer system known to those skilled in the art that is capable of being configured for use with investment profile system 400 as described herein. This includes laptop computers, desktop computers, tablet computers, pen-based computers and the like. Additionally, handheld and palmtop devices are also specifically included within the description of devices that may be deployed as an information providing computer system 48. It should be noted that no specific operating system or hardware platform is excluded and it is anticipated that many different hardware and software platforms may be configured to create information providing computer system 480. As previously explained in conjunction with data server 430, various hardware and software components (not shown this FIG.) known to those skilled in the art may be used in conjunction with information providing computer system 480.

Network 420 is any suitable computer communication link or communication mechanism, including a hardwired connection, an internal or external bus, a connection for telephone access via a modem or high-speed T1 line, infrared or other wireless communications, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 420 may suitably include a dial-up phone connection, broadcast cable transmission line, Digital Subscriber Line (DSL), ISDN line, or similar public utility-like access link.

In the most preferred embodiments of the present invention, network 420 represents and comprises a standard Internet connection between the various components of investment profile system 400. Communication link 420 provides for communication between the various components of investment profile system 400 and allows for relevant information to be transmitted from device to device. In this fashion, a user can quickly and easily gain access to the relevant data and information utilized to create and evaluate investment opportunities as described in conjunction with the preferred embodiments of the present invention. Regardless of physical nature and topology, network 420 serves to logically link the physical components of investment profile system 400 together, regardless of their physical proximity. This is especially important because in many preferred embodiments of the present invention, data server 430, information requesting computer system 470, and information providing computer system 480 will be geographically remote and separated from each other.

In general, data server 430 processes requests for various transactions between information requesting computer system 470 and information providing computer system 480. A typical transaction may be represented by a request for information relative to an existing or new qualified entity, an existing or new investor or pooled investment entity, or information request regarding a specific set of circumstances for a new or existing pool of insured lives. In this case, a request for information is sent from information requesting computer system 470 to data server 430. Data server 430 processed the request, formats the request for processing by and transfers the requested request to information requesting computer system 470. The requested information may include queries relative to organizations and entities seeking investment as well as information regarding the performance of actual or proposed investment opportunities.

In some case, the requested information may be fully contained and accessible by making requests to data server 430. However, in certain preferred embodiments of the present invention, a request for information sent from information requesting computer system 470 to data server 430 may require additional data or information not directly available to data server 430. In that case, data server 430 may request and receive data and information from information providing computer system 480 relative to a specific request from requesting computer system 470 to data server 430.

It should be noted that the roles of information requesting computer system 470 and information providing computer system 480 may be interchanged, depending on which system initiates the request. Additionally, it should be noted that while FIG. 4 shows only a single information requesting computer system 470 and a single information providing computer system 480, it is anticipated that the most preferred embodiments of the present invention will comprise hundreds and even thousands of information requesting computer systems 470 and computer systems 480.

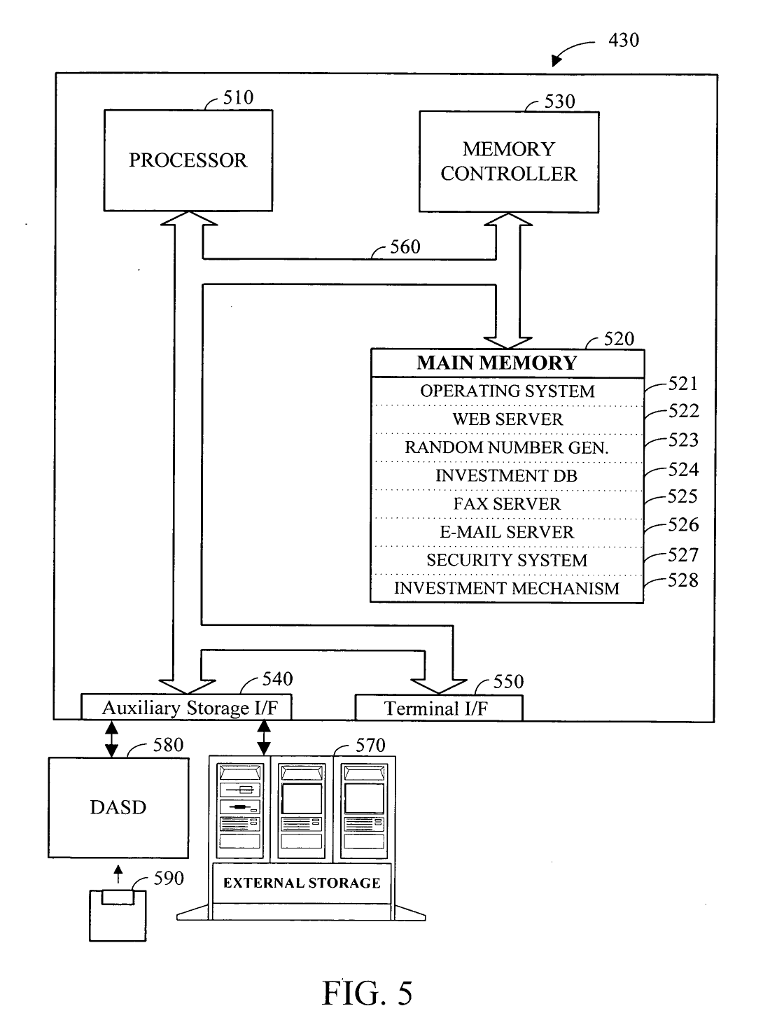

In the most preferred embodiments of the present invention, multiple information requesting computer systems 470 and multiple information providing computer systems 480 will all be configured to communicate with data server 430 and with each other via network 420. In addition, the most preferred embodiments of the present invention include an Application Service Provider (ASP) environment where data server 430 is operated as a clearinghouse in a hosted operation. In this fashion, multiple information requesting computer systems 470 and information providing computer systems 480 will have access to data server 430 on a subscription or pay-for service basis. Data server 430 is further described below in conjunction with FIG. 5 below.

Optional printer 410 and an optional fax machine 440 are standard peripheral devices that may be used for outputting transactions, reports, etc. in conjunction with the investment queries and transactions processed by investment profile system 400. Optional printer 410 and an optional fax machine 440 may be directly connected to network 420 or indirectly connected via any or all of information requesting computer systems 470, information providing computer systems 480 and data server 430. Finally, it should be noted that optional printer 410 and optional fax machine 440 are merely representative of the many types of peripherals that may be utilized in conjunction with investment profile system 400. It is anticipated that other similar peripheral devices will be deployed in the various preferred embodiment of the present invention and no such device is excluded by its omission in FIG. 4.

Referring now to FIG. 5, a data server 430 in accordance with a preferred embodiment of the present invention is a commercially available computer system such as a Linux-based computer system, IBM compatible computer system, or Macintosh computer system. However, those skilled in the art will appreciate that the methods and apparatus of the present invention apply equally to any computer system, regardless of whether the computer system is a traditional “mainframe” computer, a complicated multi-user computing apparatus or a single user device such as a personal computer or workstation.

Computer 430 suitably comprises at least one Central Processing Unit (CPU) or processor 510, a main memory 520, a memory controller 530, an auxiliary storage interface 540, and a terminal interface 550, all of which are interconnected via a system bus 560. Note that various modifications, additions, or deletions may be made to computer system 430 illustrated in FIG. 5 within the scope of the present invention such as the addition of cache memory or other peripheral devices. FIG. 5 is not intended to be exhaustive, but is presented to simply illustrate some of the salient features of computer system 430.

Processor 510 performs computation and control functions of computer 430, and comprises a suitable central processing unit (CPU). Processor 510 may comprise a single integrated circuit, such as a microprocessor, or may comprise any suitable number of integrated circuit devices and/or circuit boards working in cooperation to accomplish the functions of a processor. Processor 510 suitably executes one or more software programs contained within main memory 520.

Auxiliary storage interface 540 allows computer 430 to store and retrieve information from auxiliary storage devices, such as external storage mechanism 570, magnetic disk drives (e.g., hard disks or floppy diskettes) or optical storage devices (e.g., CD-ROM). One suitable storage device is a direct access storage device (DASD) 580. As shown in FIG. 5, DASD 580 may be a floppy disk drive that may read programs and data from a floppy disk 590. It is important to note that while the present invention has been (and will continue to be) described in the context of a fully functional computer system, those skilled in the art will appreciate that the mechanisms (particularly Investment DB 524 and/or investment transaction mechanism 528 of FIG. 5) of the present invention are capable of being distributed as a program product in a variety of forms, and that the present invention applies equally regardless of the particular type or location of signal bearing media used to actually carry out the distribution. Examples of signal bearing media include: recordable type media such as floppy disks (e.g., disk 590) and CD ROMS, and transmission type media such as digital and analog communication links, including wireless communication links.

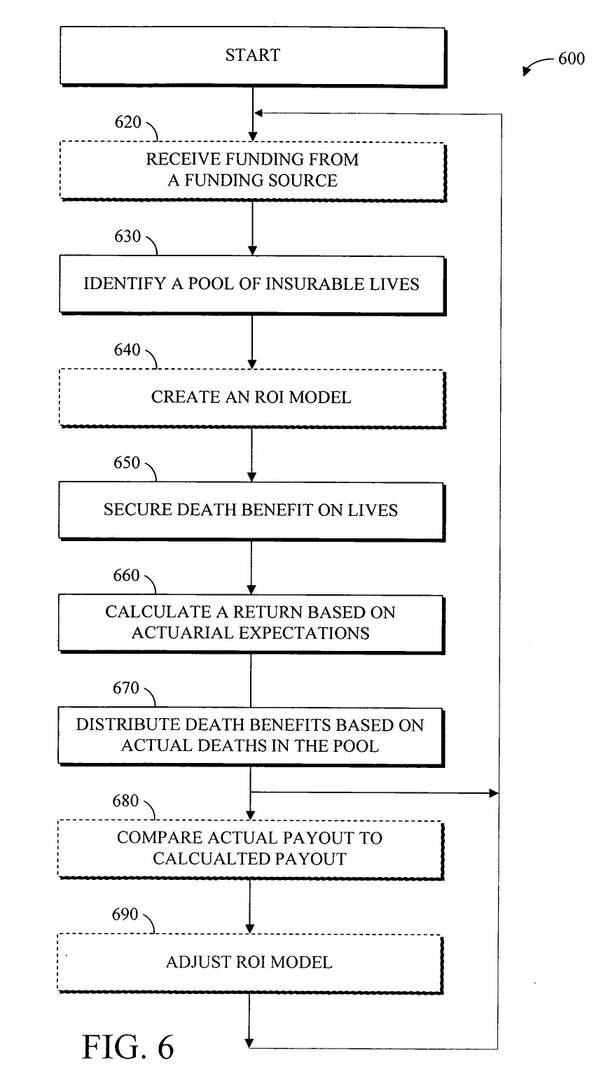

In the most preferred embodiments of the present invention, the program product will be configured to: identify a pool comprising a plurality of individuals; identify the payments required to secure death benefits on a plurality of lives in said pool; identify death benefits secured by said payments; and calculate an expected return derived from said death benefits using an actuarial expectation of death for said lives. Using this information, the insurance products can be procured manually or automatically by interfacing with the appropriate entities (i.e., pooled entities, qualified entities, insurance companies, etc.). In this fashion, the program product can also be configured to perform substantially all of the steps depicted in FIG. 6, including matching suitable entities, tracking and providing funds transfers for securing insurance products, tracking deaths of insured lives, and transferring actual death benefit payments to appropriate entities.

Memory controller 530, through use of an auxiliary processor (not shown) separate from processor 510, is responsible for moving requested information from main memory 520 and/or through auxiliary storage interface 540 to processor 510. While for the purposes of explanation, memory controller 530 is shown as a separate entity; those skilled in the art understand that, in practice, portions of the function provided by memory controller 530 may actually reside in the circuitry associated with processor 510, main memory 520, and/or auxiliary storage interface 540.

Terminal interface 550 allows users, system administrators and computer programmers to communicate with computer system 430, normally through separate workstations or through stand-alone computer systems such as information requesting computer systems 470 and information providing computer systems 480 of FIG. 4. Although computer 430 depicted in FIG. 5 contains only a single main processor 510 and a single system bus 560, it should be understood that the present invention applies equally to computer systems having multiple processors and multiple system buses. Similarly, although the system bus 560 of the preferred embodiment is a typical hardwired, multi-drop bus, any connection means that supports bi-directional communication in a computer-related environment could be used.

Main memory 520 suitably contains an operating system 521, a web server 522, a random number generator 523, an investment database (DB) 524, a fax server 525, an e-mail server 526, a security system 527, and an investment transaction mechanism 528. The term “memory” as used herein refers to any storage location in the virtual memory space of computer 430.

It should be understood that main memory 520 may not necessarily contain all parts of all components shown. For example, portions of operating system 521 may be loaded into an instruction cache (not shown) for processor 510 to execute, while other files may well be stored on magnetic or optical disk storage devices (not shown). In addition, although investment transaction mechanism 528 is shown to reside in the same memory location as operating system 521, it is to be understood that main memory 520 may consist of multiple disparate memory locations. It should also be noted that any and all of the individual components shown in main memory 520 may be combined in various forms and distributed as a stand-alone program product.

Operating system 521 includes the software that is used to operate and control computer 430 of FIG. 4. In general, processor 510 typically executes operating system 521. Operating system 521 may be a single program or, alternatively, a collection of multiple programs that act in concert to perform the functions of an operating system. Any operating system known to those skilled in the art may be considered for inclusion with the various preferred embodiments of the present invention.

Web server 522 may be any web server application currently known or later developed for communicating with web clients over a network such as the Internet. Examples of suitable web servers 522 include Apache web servers, Linux web servers, and the like. Additionally, other vendors have developed or will develop web servers that will be suitable for use with the various preferred embodiments of the present invention. Finally, while depicted as a single device, in certain preferred embodiments of the present invention web server 522 may be implemented as a cluster of multiple web servers. This configuration provides additional robustness for system uptime and reliability purposes. Regardless of the specific form of implementation, Web server 522 provides access, including a user interface, to allow individuals and entities to interact with investment transaction mechanism 528, including via network 420 of FIG. 4.

Random number generator 523 is representative of any process or procedure suitable for generating random numbers known to those skilled in the art.

Investment DB 524 is any computer program suitable for creating and/or maintaining a database of information relative to the investment methodologies presented herein. This includes custom database programs as well as commercially available “off-the-shelf” database packages provided by software vendors. Preferably, Investment DB 524 is a Structured Query Language (SQL) compatible database file capable of storing broker information, including names, addresses, account preferences, etc. Additionally, Investment DB 524 will also store information relative to the various insurance products offered by one or more insurance companies including products, premiums and rate information, etc. While Investment DB 524 is shown to be residing in main memory 520, it should be noted that Investment DB 524 may be physically located in a location other than main memory 52. For example, Investment DB 524 may be stored on external storage device 570 or DASD 580 and coupled to data transaction server 430 via auxiliary storage I/F 540.

Investment DB 524 contains information such as: actual or prospective investor or investment entities; pool of insurable lives; pool of insured lives; various industry standard actuarial and/or mortality tables; current investments and the performance of the investments; qualified entities; etc. It should be noted that this list is merely representative and not exhaustive of the types of information that may be contained in Investment DB 524. For example, in at least one preferred embodiment of the present invention, Investment DB 524 will contain a series of “profiles” for the various entities involved in the transaction described in conjunction with FIGS. 1-3. The profiles would contain information regarding each entity and highlight the type of investment transactions and deal parameters that a given entity may be interested in investing in.

Accordingly, there may be a “qualified entity profile” describing each qualified entity that may be involved in an investment transaction, including the pool of insurable lives associate with the qualified entity. Similarly, there may an “insurance company” profile for each insurance company, detailing the types of life insurance products available from each insurance company (as well as premium rates, cost of insurance, etc.), a series of “funding source” profiles and “investor” profiles with the relevant parameters for each of these entities as well, including ROI information and available investment funds, for example.

By extension, each and every parameter necessary to create and/or evaluate any proposed investment transaction may be found in Investment DB 524. The creation of the various profiles may be managed by the entities themselves via a standard web browser. The entities can use their web browser to access web server 522, thereby creating, updating and otherwise entering the relevant information for their respective profiles.

It should be noted that Investment DB 524 may be stored at a geographically remote location that is accessible via the Internet, by utilizing any suitable Internet file transfer application (XML, SOAP, etc.). In this type of distributed database environment, Investment DB 524 may be implemented using various techniques known to those skilled in the art to prevent data redundancy and to ensure data integrity. Additionally, in the most preferred embodiments of the present invention, information for various file transfer protocols and specifications for communicating with computer systems 470 and 480 of FIG. 4 are also contained in Investment DB 524.

Fax server 525 is any fax server known to those skilled in the art and is configured to receive inbound fax messages and to transmit outbound fax messages. Fax server 525 may format and transmit any data processed by investment profile system 400 of FIG. 4 and make it available for use by any other component of investment profile system 400 of FIG. 4. Additionally, fax server 525 may process the data received and send it directly to Investment DB 524 and make the incoming data for further processing by investment profile system 40, including investment transaction mechanism 528.

While not required, the most preferred embodiments of data server 430 of FIG. 4 will typically include an e-mail server 526. E-mail server 526 is any e-mail server application capable of being configured and used to send and receive various status messages and updates between computer systems 470 or 480 of FIG. 4 via e-mail, as may be necessary to enhance the overall process of investing as described herein. This includes the generation of automated e-mail messages relating to the preferred embodiments of the present invention related to investors, investment entities, qualified entities, insured lives, return on investment, etc.

Security system 527 is any known security system or application and represents a security and/or encryption facility for verifying access to the data contained in and transmitted by data server 430. Additionally, security system 527 may also provide encryption capabilities for investment profile system 400, thereby enhancing the robustness of investment profile system 400. Once again, depending on the type and quantity of information stored in Investment DB 524, security system 527 may provide different levels of security and/or encryption for different computer systems 470 and 480. Additionally, the level and type of security measures applied by security system 527 may be determined by the nature of a given request and/or response. In some preferred embodiments of the present invention, security system 527 may contained in or implemented in conjunction with certain hardware components (not shown this FIG.) such as hardware-based firewalls, switches, dongles, and the like.

Investment transaction mechanism 528 is most preferably a software application program configured to provide various analytical, organizational, computational, and reporting capabilities for the user of investment profile system 400. This includes: identifying, analyzing and selecting various investment opportunities; identifying and selecting individuals for inclusion or exclusion in a pool of insured lives; analyzing and selecting various insurance products for use in implementing a given investment strategy as described in conjunction with FIGS. 1-3; tracking and reporting on the status of the insured lives in a given pool; calculating, analyzing and reporting the return on investment for a given scenario; and other similar tasks as may be required to successfully implement the preferred embodiments of the present invention.

Additionally, in at least one preferred embodiment of the present invention, Investment transaction mechanism 528 utilizes the various entity profiles stored and maintained in Investment DB 524 to identify appropriate entities for various investment scenarios. For example, if a funding source entity is willing to provide a certain amount of funds, that entity can make its desire to participate in an investment, including pertinent factors such as amount to be invested and desired ROI.

Next, investment transaction mechanism 528 can identify appropriate entity profiles within Investment DB 524 for participation in creating the participating qualified entity or entities, investors or pooled investment entity or entities, and selecting the appropriate group of insurable individuals necessary to achieve the desired ROI. Similarly, investment transaction mechanism 528 can identify the appropriate life insurance products and corresponding insurance company entity, based on their profile, for completing the contemplated transactions. In certain preferred embodiments of the present invention, investment transaction mechanism 528 is configured to interact with Investment DB 524 and procure at least one insurance product to secure the desired death benefits on the insured lives in the pool of insured lives.

Referring now to FIG. 6, an investment method 600 in accordance with a preferred embodiment of the present invention is depicted. As shown in FIG. 6, the method typically involves a pooled investment entity, which receives funds from investors, thereby creating a funding source, which provides funds for investment (step 620). It should be noted that the funding source may be an individual, a group of investors, a financial institution or any other similar person, entity or organization that is capable of providing the necessary funds for the procurement of the desired insurance products.

The next step in method 60 is to identify a pool of insurable lives (step 630) from which a pool of insured lives will be obtained. It should be noted that the lives needed to create the pool of insured lives for a given proposal will be selected based upon their age, health, insurability, and other similar factors. While the pool of insured lives selected from the pool of insurable lives may be of any suitable size, the most preferred embodiments of the present invention will typically include at least 50 insured lives in a pool and, based on various requirements of the insurance companies and investment rating companies involved, may be more typically in the range of 2,000 insured lives. While 50 insured lives is a viable number for the present invention, it should be noted that a pool of this size is generally considered unacceptable for traditional life insurance pools where death benefit payments are based on actuarial events occurring in the pool.

Additionally, it should be noted that the pool of insured lives may or may not be a subset of the identified pool of insurable lives. For example, a given qualified entity or other source may have a very large pool of insurable lives available but only a portion of those insurable lives may be selected for inclusion in the pool of insured lives. In that case, the pool of insured lives is smaller than the pool of insurable lives. Additionally, since the pool of insured lives may be drawn from multiple pools of insurable lives or other sources, the pool of insured lives may be larger than the pool of insurable lives for a given entity, and the individual lives within the pool of insurable lives will typically be donors to the qualified entity or other source.

Another aspect of the preferred embodiments of the present invention is defining the selection criteria and investment profile system age range of the members of the pool of insured lives. Based upon the ratio of premium costs to total death benefit face amounts for selected insurance products available for various carriers, the most preferred age range for male and female lives is 65-75 years. As previously explain in conjunction with FIG. 5, the various insurance products and associated premium information and actuarial information is contained in Investment DB 524 of FIG. 5 and processed in conjunction with method 60.

While not required, method 600 typically includes the creation of an ROI model (step 64). This ROI model may be a computer-based model implemented using the components described in conjunction with FIG. 4 and FIG. 5, or a manually created ROI model and may include elements such as target ROI for one or more investment profiles, various insurance product components with associated rates or returns, sample and model populations, etc. In the most preferred embodiments of the present invention, the model will be developed in conjunction with investment profile system 400 of FIG. 4.

In this embodiment of the present invention, the “pricing” for a given investment will be determined by the entities participating in any given transaction as described herein. For example, given the available pool of insurable lives associated with a given qualified entity, using certain life insurance products, it is possible to establish the projected ROI for the pooled investment entity and investors involved. Upon the death of the insured lives, the death benefit may be bifurcated and paid to the pooled investment entity/investors and the qualified entity, based on a previously agreed upon ratio. Accordingly, while a projected ROI is determined using the actuarial expectation of death within the pool of insured lives at the time the pool of insured lives is created; the actual ROI will be based on actual deaths in the pool of insured lives.

This means that the projected ROI and the actual ROI may be different. However, over time, as the various ROI models are adjusted (step 69) and, given a pool of sufficient size so as to be statistically accurate, it is anticipated that the actual ROI and the projected ROI will be substantially the same. This will allow the investors to achieve their desired ROI while the qualified entities will receive the agreed upon apportionment of money from the payment of death benefits for their purposes. It should be noted that the timing of the return on investment for the investors is based on a substantially unpredictable and uncontrollable series of events and can only be estimated by actuarial data beforehand and measured precisely after the fact.

One step in the development of the ROI model is the generation of a hypothetical “population” upon which to base the actuarial experience of the proposed pool and the corresponding payout based upon the actuarial projection from probability distributions derived from actuarial tables. This is typically accomplished by using an acceptable probability distribution in conjunction with a random number generator to “seed” the model. Then, the hypothetical population can be modeled and the desired projections as to actuarial expectations can be made, based upon the population. Demographic characteristics of the desired population can also be modeled in this fashion to ensure that the model has the desired ROI for a given investment purpose. It should be noted that if the projected ROI is not acceptable, given the profile of the members in the pool of insured lives, then factors such as the number of lives in the pool of insured lives, the demographic makeup of the pool of insured lives, and/or the insurance products selected for the insured lives may be adjusted as necessary.

Next, one or more suitable life insurance products are selected in order to secure a death benefit (step 650) on a plurality of lives from the pool of insurable lives, thereby creating a pool of insured lives. Once the pool of insured lives has been established, it is possible to utilize probabilities found in standard actuarial and mortality tables to calculate, with acceptable confidence, a projected ROI using actuarial projections (step 66). It should be noted that, as used herein, the term “calculate” means any or all of the following: obtaining; graphing; getting; hypothecating; estimating; and the like. Any method or methods known to those skilled in the art that will yield a projected ROI from the specified data may be suitably employed to accomplish the desired results of method 60. Then, once finalized as members in the pool of insured lives die, actual death benefits are paid by the insurance company (step 670).

Next, with the passage of time, the pool of insured lives will ultimately generate actual death benefit payouts, which may be compared to the originally predicted death benefit payouts (step 680) contemplated and projected by method 60. This being the eventual case, rating agencies may or may not be engaged to independently value the pool of insured lives from time to time during its duration by using existing or future actuarial tables. Observed variations will be limited to the timing of eventual death benefit payments. As the benefit payments are based on insurance product contracts, it is highly unlikely to observe variations in the number of eventual payments and the dollar amounts associated with these payments.

Next, subject to the timing variations observed in step 680, adjustments to the model relative to ROI for future payout projections (step 690) may be completed by changing the present value calculations. This is accomplished by changing the timing of the payments that directly changes the computed ROI using contemporaneous actuarial tables.

Those skilled in the art will recognize that, depending on the entities involved, steps 620, 630, and 640 may be interchanged and executed in any desired order. Additionally, step 660 may be performed multiple times in order to achieve the desired results.

By referring to method 600 depicted in FIG. 6, the following observations regarding several important points of the present invention when implemented using a qualified entity, may be made. For example, the lives insured by the insurance products, financed all or in part by the pooled investment entity, need not be donors to a specific qualified entity. They may be any other lives within a pool of insured lives on which life insurance can be obtained. The lives needed to create the pool of insured lives will be selected based upon their age, health, and insurability. Funding of the life insurance product premiums may come directly from the pooled investment entity or it may be obtained using funds from any other source, but the assets of the pooled investment entity are typically directly or indirectly committed by some means to facilitate securing of the life insurance products. Additionally, the pool of insured lives may be comprised of insurable lives associated with any number of entities and may not all be associated with a single entity.

In the case of individuals selected by a qualified entity, the individuals are “donating” a portion of their life insurance capacity to the qualified entity. The life insurance policy purchased on such an individual could be all or partially owned by the qualified entity, a selected qualified entity or another qualified entity. The pooled investment entity may act as the sole or a partial owner of each individual policy, or it need not be an owner of any of the insurance products. The pooled investment entity may be named as the sole or a partial beneficiary of the insurance products, or it need not even be named as a beneficiary.

However, in the most preferred embodiments of the present invention, the pooled investment entity will be the beneficiary of all or at least a portion of the life insurance benefits paid on the death of lives insured within the pool of insured lives. In exchange for allowing the pooled investment entity to “borrow” the lives of the qualified entity's donors, the pooled investment entity will donate all or a portion of the life insurance benefit to the qualified entity. The donation will usually be made following the donor's death after the associated death benefit is received by the pooled investment entity. The donation will usually be made directly from the pooled investment entity, which is the beneficiary of the death benefits payable upon the death of the insured life or lives.

In other preferred embodiments of the present invention, the qualified entity might be named as the total or a partial beneficiary of one or more of the death benefits payable upon the death of one or more of the insured individuals within the pool of insured lives. In this case, the death benefits payable for any given individual life may be pre-assigned to either the pooled investment entity or the qualified entity, as pre-agreed and in accordance with a percentage of the total number of insured lives within the pool. In other preferred embodiments, a third party, such as a trust, may be designated or named as the beneficiary of all or part of the death benefit on one or more of the insured lives within the pool of insured lives, and the death benefits will be distributed among the pooled investment entity, investors, qualified entity or others as agreed upon by the parties.

An insured within the pool of insured lives may designate a family member or other designated beneficiary of all or a part of the insurance benefit payable upon his or her death, if such a designation is permitted by agreement among the parties. In the most preferred embodiments of the present invention, at least one insurance product with an associated death benefit will be procured for each life in the pool of insured lives. It is also within the scope of the present invention to create an embodiment where multiple insurance products will be procured for one of more of the lives in the pool of insured lives. Finally, it is also anticipated that certain embodiments of the present invention will provide for coverage of multiple insured lives with a single life insurance product.

Based upon the actuarial expectation of death within the pool of insured lives, the investment return, i.e., profit or loss, achieved using the assets committed by the pooled investment entity can be calculated or “projected.” The mathematical calculations used to make such projections are well known to those trained in the art of actuarial predictions and may be prepared by using investment transaction mechanism 528 of FIG. 5 as described in conjunction with investment profile system 400 of FIG. 4. Assuming that the pool of insured lives is sufficiently large, the insurance company honors its contracts, and a number of other considerations are taken into account, the return on investment projected should be quite certain.

All or a portion of the life insurance benefits (death benefits), payable upon the death of a life insured within the pool of insured lives, may be paid, directly or indirectly, to the pooled investment entities and used to return the invested assets that investors have transferred to the pooled investment entity. All or a portion of the life insurance benefits (death benefits), payable upon the death of a life insured within the pool of insured lives, may be used to return not only the original assets invested by each investor, but also pay an increase for use of the investor's capital. The present invention is unique, because the present value of the assets committed by the pooled investment entity is not a factor in projecting the return on the investment.

Because the pooled investment entity is a pass-through entity, the tax consequences of the death benefit payment from the life insurance company to the pooled investment entity will more likely than not flow through to the individual investors. As the death benefits are moved through the pooled investment entity to the individual investor, the death benefits may be received by the individual investor as a return of capital and/or an increase, without any income tax due. It is a well-established principle of tax law that, in most cases, a recipient of a death benefit paid on life insurance does not have to recognize the payment as income.

In many embodiments of the present invention, investments made into the pooled investment entity by investors may be able to yield tax-advantaged returns from various sources. For example, the pooled investment entity may be able to borrow from the cash values of the life insurance policy to yield a tax-free income to its investors. The pooled investment entity may receive all or a portion of the life insurance death benefit upon the death of the insured, which benefit may pass to the pooled investment entity investors tax-free. All or a portion of the death benefit, on specific policies, may be contributed by the pooled investment entity to a qualified entity, and the pooled investment entity may receive a tax advantage for making the contribution, which tax advantage may, in turn, pass through to the individual investors in the pooled investment entity and may allow them to claim a reduction in taxes.

In all of its embodiments, the present invention makes use of investment principals, actuarial expectancies, and unique economic aspects of life insurance products. Additionally, the present invention uses, tax laws associated with life insurance, qualified entities and pooled investment entities to achieve an excellent increase, or “return on investment,” for investors in the pooled investment entities and also for qualified entities, should such qualified entities be included within the structure of the investment plan.

The methods contained herein differ from traditional investments in a number of significant ways. For example, although individuals may invest in insurance companies, they are actually buying equity instruments representing an underlying ownership of the insurance company proper. Individuals are not investing in the death benefits paid by the insurance company to the beneficiaries of the policies issued by the insurance company. In the various preferred embodiments of the present invention, the individual investors are investing through the pooled investment entity directly in insurance products. Pooled investment entities will generally invest in various types of investments, but it is novel to invest in the death benefits paid by an insurance company on the death of a person, which is an underlying principle of the current invention. More specifically, it is novel to invest when the expectation of return is based upon the actuarial expectation of death within a pool of insured lives.

Similarly, although insurance companies create pools of insured lives, they do not invest in the death benefits associated with the policies that they issue. The insurance companies calculate premiums based on actuarial tables but invest in stocks, bonds, etc. in order to earn a return based on interest rates, usury charges, or equity growth in the equity instruments the premiums are used to purchase. Insurance companies are not projecting an ROI based on receiving death benefits associated with projected actuarial events but rather based on the performance of their investment portfolio.

With most traditional investments made by investment entities, the amount of the return and/or the timing of the receipt of the return can be controlled. For example, when investing in the stock market, an investor can typically sell the stock at a time of their choosing and then receive their return on investment. While the exact amount of the return may be uncertain, the timing is within the control of the investor. Similarly, an investor can bargain for a specific rate of return and than, based on the performance of the investment, receive a return at the specified time. Finally, an investor can also choose to receive a guaranteed return at a guaranteed period of time by investing in certificates of deposit, bonds, etc.

In contrast, the present invention specifically provides an investment vehicle for investing in the death benefit of the insurance policies themselves, not in the equity ownership of the insurance company and not in the investment instruments owned by the insurance company.

Various alternative preferred embodiments of the present invention will be readily understood by those skilled in the art, once the basic concepts and methodologies of the presented invention have been explained as in the examples shown in FIGS. 1-6. For example, the pooled investment entity could transfer money to the qualified entity it is participating with, and the qualified entity could purchase and own one or more of the life insurance policies. The qualified entity may or may not name the pooled investment entity as a beneficiary of all or a portion of the death benefit payable on such polices. Any person or entity that has an insurable interest in one or more lives, upon which life insurance can be issued, could act as owner of the policies. Such a person or entity would effectively participate with the pooled investment entity in order to achieve the desired results, i.e., return of the pooled investment entity's invested assets with an increase resulting from the purchase of life insurance or other products offered by life insurance companies.

It is possible, through the use of a foreign life insurance company or other mechanism, that the owner of the policy or policies purchased or secured, directly or indirectly, using the pooled investment entity's capital may not be required to have in insurable interest in the lives actually insured.

It is certainly possible that the assets of the pooled investment entity could be passed through one or more entities or persons prior to the actual use of the assets to secure the life insurance products. Rather than have the pooled investment entity's assets directly purchase the life insurance products, it would certainly be possible to use the pooled investment entity's assets as collateral to secure leveraged funds that could be used to actually purchase the life insurance products. Prior to disclosure of this invention it would have been counter intuitive to have asked a pooled investment entity to supply the collateral for such a loan. The investors in a pooled investment entity are typically pooling their money with the expectation of a profit through traditional means of investing. It is novel to use a pooled investment entity's capital to directly or indirectly secure or “purchase” life insurance on lives in a pool of insured lives, particularly where any investment return expected is calculated or dependant, in any respect, upon the actuarial expectation of death within the pool of insured lives.

In one embodiment of the current invention it would be possible for a pooled investment entity to own and receive the entire benefit for the life insurance on a life, such as the life of a donor to a qualified entity, in the pool of insured lives. Upon the death of the insured, the pooled investment entity could, but need not, contribute some or all of the benefit to a qualified entity and receive a tax benefit that would be passed through to investors in the pooled investment entity.

In another embodiment of the current invention, a pooled investment entity could make a donation of assets to a qualified entity, and the qualified entity could purchase life insurance on the life of one or more individuals, such as donors to the qualified entity. The qualified entity and/or the pooled investment entity could be named as the beneficiary of all or a part of such life insurance. In this embodiment, the life insurance allows the qualified entity to “leverage” all or a portion of the donation by purchasing life insurance products. Upon the death of the insured, the life insurance policy will pay a death benefit to the beneficiaries named on the policy. The qualified entity may be named on the policy in order to recover the money it used to purchase the policy and receive a gain on the money it used to purchase the policy. Other beneficiaries could also be named. If the pooled investment entity was not named as a beneficiary, it would still be possible to receive a return from the beneficiary through a contractual arrangement. It is also possible to make the pooled investment entity the collateral assignee of the policy rather than a beneficiary.

In this embodiment, is should be noted that all of the money, which the pooled investment entity originally donated to the qualified entity, is used by the qualified entity for its purposes. It has simply used part of its money to purchase life insurance products.

Also, in this embodiment, the investors' object of a return of their assets, with a gain, is achieved through the death benefits payable to the pooled investment entity. Additionally, when the pooled investment entity made the donation to the qualified entity, the pooled investment entity's investor indirectly had an immediate increase in wealth through applying the tax deduction, realized from the pooled investment entity's donation, to reduce taxes. The tax result is the same as if the investor had made the donation directly to the qualified entity. Additionally, the qualified entity has achieved its objective by increasing its donations. It has had immediate control and use of the donated assets, but has postponed the enjoyment of the assets in order to substantially increase the value of the assets for future enjoyment. Upon the death of the insured, the qualified entity will receive the “leveraged” growth of the asset (the donation from the pooled investment entity) which it can use as it pleases. The qualified entity could use the asset received to purchase life insurance on other lives to further expand the asset for future use and enjoyment.

It should be noted, that in any of the preferred embodiment of the present invention, supplemental investments, in addition to life insurance product purchases, might be made by the pooled investment entity. Accordingly, the present invention, in any of its preferred embodiments, creates a vehicle that can be fully or partially conjoined with traditional tax-exempt investment instruments to create taxable and/or tax free returns on investment. The present invention, in all of its various preferred embodiments, provides investors with a unique opportunity to invest directly in the financial strength of products of the life insurance industry, not simply in the equity instruments that provide ownership of the underlying insurance companies.

As shown by the discussion above, the various methods of the present invention enable a unique and novel combination of pooled investment entities, qualified entities, lenders financing the purchase of life insurance products, and traditional investments used together to yield a greater return to investors in the pooled investment entity.

From the investor's perspective, the present invention creates a new type of synthetic investment unit having a tax advantaged component, thereby allowing the investor to receive tax-advantaged income and claim reductions in income taxes, which improves upon the existing body of knowledge relating to pooled investment entities and general market practices and performances. The present invention also provides the potential for greater monetary growth for each individual investor, by not only allowing the investor to realize a possible reduction in taxes, but also allowing the investor to receive the tax advantaged benefits afforded life insurance cash values and death benefits, as defined by the United States Internal Revenue Service Tax Code (IRS Tax Code).

The present invention creates a way to supply individuals with life insurance and deliver life insurance benefits to their families. Some individuals, who meet the required health and other insurability standards set by the insurance companies and the actuarial parameters required for this invention, cannot obtain life insurance because they simply cannot afford the cost. Upon their death, their family must be supported through government assistance, because no life insurance benefit was purchased on their life. This invention will create a way of providing such individuals with life insurance benefits that will help support their families after their death. Thus, the support required from government assistant (tax payers) will be reduced or eliminated by the current invention.

Unlike conventional approaches to social activism, the methods and processes of the present invention create an attractive investment and a means for “qualified entities” to raise money for their worthy social causes. The present invention creates a new process for solicitation by qualified entities to encourage giving by entities and individuals. The present invention also creates a significant new source of donations for qualified entities. It creates an entirely new source of support for qualified entities. Thus, society can be greatly benefited by implementing the various preferred embodiments of the present invention, which substantially increases the ability of qualified entities to fund the causes they represent.

The purchase of life insurance on the life of a significant donor to the qualified entity or a purchase of life insurance on other individuals by a qualified entity is not a novel concept. However, for many reasons it is not commonly done. Qualified entities normally do not have enough income to invest and forgo using the income immediately to meet current expenses. This is particularly true when purchase of a life insurance policy is considered as the use of the qualified entity's income, because the life insurance policy doesn't give any tax advantage to the qualified entity, and it does not give any type of an income stream to the qualified entity. The purchase of life insurance by the qualified entity on its donors or others is not commonly considered, because any realization of wealth from the purchase will potentially be postponed for many years until the insured dies. Additionally, the qualified entity doesn't think to ask its donors or others for a “gift,” which requires the qualified entity to expend large amounts of its funds to realize.

It should be noted that when an individual permits a qualified entity or a pooled investment entity to purchase a life insurance policy on his or her life, the individual is actually using a portion of his or her insurable interest. In the case of a donor to a qualified entity, the donor is actually making a gift of a portion of his or her insurable capacity to the qualified entity, assuming the qualified entity will receive a benefit from the insurance. Typically, the individual whose life is being insured must give the qualified entity and/or the pooled investment entity permission to make such a life insurance purchase and must generally participate in the process of obtaining the life insurance. Insurance companies will only issue a finite amount of insurance on a given individual. When that finite amount has been reached and issued, the insurance companies will not issue any more insurance, because the individual's insurable capacity would be surpassed.

The present invention creates a new and very large market for the life insurance industry. Providing life insurance to facilitate the current invention will provide an extremely large market for the life insurance industry with many more lives insured.

Actuarial expectations of death in a pool of insured lives effectively measure the risk of loss to the insurance companies and the length of time the insurance companies will have the premium dollars to invest. In the current invention the investment return is dependant upon the actuarial expectation of death in the pool of insured lives, not on what the insurance company does with the premium dollars, i.e., how the insurance company invests its assets and what the returns on those investments are, or on how long the insurance company has the premium funds to invest. The insurance company is not basing its investments on the actuarial expectancy of life or death within the pool of insured lives. The investments are made in standard stocks, bonds, and other financial vehicles. The actuarial expectation of length of life simply tells the insurance company how long they will have the investment working to produce a return. The concept of basing an investment on the actuarial expectation of death in a pool of insured lives is a novel part of the current invention. Although purchasing life insurance is a common practice, purchasing it on many lives and creating a potential for financial returns for investors in a pooled investment entity, which return is dependent to any degree on the expectation of death in a pool of insured lives is not done under the current art.

A company, family limited partnership, irrevocable life insurance trust, or other entity can and often does purchase life insurance on one or more individual lives associated with the entity. This invention discloses the use of a “donation” of a life to be insured. It is also possible that the pooled investment entity could directly or indirectly “purchase” the right to insure a life. Even a pooled investment entity may purchase life insurance on those individuals considered key to the success of the pooled investment entity. In each case the company, partnership, trusts, or other entity looks at the premium paid as a cost. In fact, they go to great lengths to figure out how to make the cost tax deductible, and they insure a minimum number of lives, because of the expense.

Money transferred to pay the premiums on a death benefit by the individual entity is typically not viewed as an investment, even though the insurance may pay a death benefit in excess of the premiums paid into the policy. The probability of profit is too speculative to become an investment vehicle with any significant value. Only by insuring very large groups of individuals can a stable return be projected. Individuals and entities do not generally look at the actuarial expectation of death in the lives for which insurance has been purchased and calculate a return on its money in order to provide a return to the contributors or investors of the entity. The policies are purchased to hedge the risk of death not to yield an actuarially calculated return on investment. Each death is looked at as a separate incident upon which a death benefit is paid. The death benefit, in whole or in part, typically goes to help the family of the deceased insured or to help the entity cope with the problems created by the death.

The object of such entities is not to create a large enough pool of lives to actuarially measure its risk or cost and certainly not to measure its return. In order to obtain a reasonable actuarial accuracy, the pool must have a large enough number of lives to insure an accurate statistical representation. To obtain the rudiments of actuarial accuracy, the most preferred embodiments of the present invention will utilize a pool of at least 50 lives. Fewer lives may certainly be used to make the actuarial calculations, but the accuracy of the calculations would be less certain and most likely undesirable. Those skilled in the art will recognize that combining a number of smaller pools of insured lives will yield the desired result, and such a pool achieved by the combination of pools will be considered a “pool of insured lives” for purposes of the present invention. Any group of two or more lives that are used to make an actuarial projection would be considered a “pool of insured lives” for purposes of the present invention. The actuarial expectancies within the pool of insured lives are used to project, but not guarantee, the timing of investment returns and thus the yield of investment returns contemplated by the current invention. Within the preferred embodiments of the present invention, the returns to investors of the pooled investment entity will be projected and promised based upon the actuarial expectation of death within the pool of insured lives rather than on the actual timing of deaths within the pool of insured lives.

Not only is the size of the pool used to make the actuarial projections of the expectation of death in the pool of insured lives important in determining possible returns to investors in the pooled investment entity, the age of each life insured within the pool of insured lives is important. The profit and loss of the pooled investment entity, and thus the returns on investment paid to investors in the pooled investment entity, will depend upon the age makeup of the insured lives within the pool of insured lives. In order to obtain better profit potentials and return potentials, lives within certain age groups will be preferentially or solely selected to be insured lives within the pool of insured lives. Thus, a “biased sample” or a “stratified sample” where lives within certain age groups are selected could be used to make the actuarial calculations that predict investment returns in the present invention. Actual selection of insured lives used to create the pool of insured lives is contemplated in the present invention. Such biased samples could be used within the present invention to improve the yields paid by the pooled investment entity to its investors and the profit that the pooled investment entity will make.

It is expected that the pooled investment entities will not only return the investment made or assets committed by investors, but also an increase. Investors, individuals or entities, may or may not be willing to transfer assets to qualified entities as an expression of their desire to further the cause or causes of the qualified entities. Investors that invest in pooled investment entities desire to increase their wealth, not support the cause of a qualified entity. Investors consider any transfer of assets to a qualified entity a loss, certainly not an investment that would be expected to yield an economic return to the transferor. Investors do make loans to qualified entities, with the expectation of a return of principal and increase.

The present invention also creates a very large market for loans that are highly secured. It will substantially stimulate the lending industry.

The present invention permits qualified entities to use borrowed money to substantially increase their endowment funds. This allows them to utilize their current income streams to meet current expenses while insuring their long-term viability.

The present invention permits pooled investment entities to use leveraged funds to substantially increase their return on investment to their investors. The leveraged funds are acquired with little or no risk to the individual investors of the pooled investment entities.

In summary, the present invention provides broad application of a unique business process where qualified entities, insurance companies, pooled investment entities, investors, the banking industry, and the public good are all benefited and served by the methods and integrated processes comprehended by the various preferred embodiments of the present invention.

Lastly, it should be appreciated that the illustrated embodiments are preferred exemplary embodiments only, and are not intended to limit the scope, applicability, or configuration of the present invention in any way. Rather, the foregoing detailed description provides those skilled in the art with a convenient road map for implementing a preferred exemplary embodiment of the present invention. Accordingly, it should be understood that various changes may be made in the function and arrangement of elements described in the exemplary preferred embodiments without departing from the spirit and scope of the present invention as set forth in the appended claims.

What is claimed is:

1. A method comprising the steps of:
identifying a pool comprising a plurality of individuals;
securing payment for death benefits on a plurality of lives in said pool; and
using an actuarial expectation of death for said lives to calculate an expected return derived from said death benefits.

2. The method of claim 1 further comprising the step of receiving payment of some or all of said death benefits based on the end of at least one of said plurality of lives, thereby creating an actual return.

3. The method of claim 1 wherein said pool comprising a plurality of individuals comprises a pool of at least 50 individuals.

4. The method of claim 1 wherein said pool comprising a plurality of individuals comprises a pool of at least 2,000 individuals.

5. The method of claim 1 wherein said expected return is an uncertain amount.

6. The method of claim 1 wherein said expected return will be received at an uncertain time.

7. The method of claim 1 wherein:
said expected return is an uncertain amount; and
said expected return will be received at an uncertain time.

8. The method of claim 2 further comprising the step of allocating all or a portion of said actual return to at least a first entity and at least a second entity.

9. The method of claim 8 wherein said first entity is a pooled investment entity.

10. The method of claim 8 wherein said second entity is a qualified entity.

11. The method of claim 8 wherein:
said first entity is a pooled investment entity; and
said second entity is a qualified entity.

12. The method of claim 1 wherein said step of securing payment for death benefits on a plurality of lives in said pool comprises the step of procuring at least one insurance product.

13. The method of claim 1 wherein said step of securing payment for death benefits on a plurality of lives in said pool involves the step of procuring at least one insurance product and further comprising the steps of:
receiving payment of some or all of said death benefits based on the end of at least one of said plurality of lives;
allocating at least a portion of said payment to at least one pooled investment entity and at least one qualified entity.

14. The method of claim 9 wherein said pooled investment entity is a pass-through entity for income tax purposes.

15. The method of claim 1 wherein said step of identifying a pool comprising a plurality of individuals comprises the step of selecting said plurality of individuals to create a biased pool.

16. The method of claim 15 wherein said biased pool is age biased.

17. The method of claim 15 wherein said biased pool is gender biased.

18. The method of claim 15 wherein said biased pool is age biased and gender biased.

19. The method of claim 1 wherein said pool comprising a plurality of individuals comprises a plurality of donors to a qualified entity.

20. The method of claim 12 further comprising the step of using assets committed by a pooled investment entity to directly or indirectly secure said at least one insurance product.

21. The method of claim 12 wherein said at least one insurance product is at least one of:
a single premium life insurance policy;
a multiple premium life insurance policy;
a permanent life insurance policy;
a term life insurance policy; and
an annuity.

22. The method of claim 12 wherein said at least one insurance product is owned partially or completely by a pooled investment entity.

23. The method of claim 12 wherein said at least one insurance product is owned partially or completely by a qualified entity.

24. The method of claim 20 wherein said step of using assets committed by a pooled investment entity to directly or indirectly secure said at least one insurance product comprises the step of using leveraged funds to procure said at least one insurance product.

25. A method of providing an increase of assets to a qualified entity comprising the steps of:
receiving assets from a pooled investment entity;
identifying a pool comprising a plurality of individuals, said plurality of individuals being donors to said qualified entity;
using said assets from said pooled investment entity to secure payment for death benefits on a plurality of lives in said pool;
calculating an expected return derived from said death benefits using an actuarial expectation of death for said plurality of lives;
receiving payment of some or all of said death benefits based on the end of at least one of said plurality of lives, thereby creating an actual return; and
allocating at least a portion of said actual return to each of said pooled investment entity and said qualified entity, thereby providing an increase of assets to said qualified entity.

26. The method of claim 25 wherein said step of calculating an expected return comprises the step of creating a model for calculating said expected return.

27. The method of claim 26 wherein said model is a computer-based model.

28. The method of claim 25 further comprising the step of comparing said expected return to said actual return and adjusting said model.

29. The method of claim 25 wherein said step of using said assets from said pooled investment entity to secure payment for death benefits comprises the step of procuring at least one insurance product.

30. The method of claim 29 wherein said at least one insurance product is at least one of:
a single premium life insurance policy;
a multiple premium life insurance policy;
a permanent life insurance policy;
a term life insurance policy; and
an annuity.

31. The method of claim 25 wherein said step of using said assets from said pooled investment entity to secure payment for death benefits on a plurality of lives in said pool comprises the step of securing at least one insurance product for each of said plurality of lives.

32. The method of claim 25 wherein said step of using said assets from said pooled investment entity to secure payment for death benefits on a plurality of lives in said pool comprises the steps of:
securing at least one insurance product for each of said plurality of lives; and
securing at least two insurance products for at least one of said plurality of lives.

33. An apparatus comprising:
at least one processor;
a memory coupled to said at least one processor; and
an investment transaction mechanism residing in said memory and being executed by said at least one processor, said investment transaction mechanism being configured to:
identify a pool comprising a plurality of individuals;
identify payments required to secure death benefits on a plurality of lives in said pool;
identify death benefits secured by said payments; and
calculate an expected return derived from said death benefits using an actuarial expectation of death for said lives.

34. The apparatus of claim 33 further comprising an operating system residing in said memory.

35. The apparatus of claim 33 further comprising a web server residing in said memory.

36. The apparatus of claim 33 further comprising a random number generator residing in said memory.

37. The apparatus of claim 33 further comprising an investment database residing in said memory.

38. The apparatus of claim 37 wherein said investment database comprises a plurality of data related to insurance products, investors, and qualified entities.

39. The apparatus of claim 33 further comprising a fax server residing in said memory.

40. The apparatus of claim 33 further comprising an e-mail server residing in said memory.

41. The apparatus of claim 33 further comprising a security system residing in said memory.

42. The apparatus of claim 33 further comprising a network coupled to said processor.

43. The apparatus of claim 42 further comprising an information requesting computer system coupled to said network.

44. The apparatus of claim 42 further comprising an information providing computer system coupled to said network.

45. The apparatus of claim 33 further comprising:
an operating system residing in said memory;
a web server residing in said memory;
a random number generator residing in said memory;
an investment database residing in said memory;
a fax server residing in said memory;
an e-mail server residing in said memory; and
a security system residing in said memory.

46. The apparatus of claim 42 further comprising:
an information requesting computer system coupled to said network; and
an information providing computer system coupled to said network.

47. An apparatus comprising:
a network;
an information requesting computer system coupled to said network;
an information providing computer system coupled to said network;
at least one processor coupled to said network;
a memory coupled to said at least one processor;
an operating system residing in said memory;
an investment database residing in said memory;
a security system residing in said memory; and
an investment transaction mechanism residing in said memory and being executed by said at least one processor, said investment transaction mechanism being configured to:
identify a pool comprising a plurality of individuals;
identify payments required to secure death benefits on a plurality of lives in said pool;
identify death benefits secured by said payments; and
calculate an expected return derived from said death benefits using an actuarial expectation of death for said lives.

48. The apparatus of claim 47 further comprising:
a web server residing in said memory;
a random number generator residing in said memory;
a fax server residing in said memory; and
an e-mail server residing in said memory.

49. A program product comprising:
an investment transaction mechanism, said investment transaction mechanism being configured to:
identify a pool comprising a plurality of individuals;
identify payments required to secure death benefits on a plurality of lives in said pool;
identify death benefits secured by said payments; and
calculate an expected return derived from said death benefits using an actuarial expectation of death for said lives.

50. The program product of claim 49 wherein said signal bearing media comprises recordable media.

51. The program product of claim 49 wherein said signal bearing media comprises transmission media.
